(19) United States
(12) Patent Application Publication
(10) Pub. No.: US 2015/0127403 A1
(43) Pub. Date: May 7, 2015

(54) CALENDAR MANAGEMENT SYSTEM

(71) Applicant: SLIDE RULE SOFTWARE, Moab, UT (US)

(72) Inventor: William PETTY, Moab, UT (US)

(21) Appl. No.: 14/494,390

(22) Filed: Sep. 23, 2014

Related U.S. Application Data
(60) Provisional application No. 61/899,051, filed on Nov. 1, 2013.

(51) Int. Cl. G06Q 10/10; G06F 3/0484; G06F 3/0481

(52) U.S. Cl. CPC G06Q 10/1093; G06F 3/0481; G06F 3/04842
USPC 705/7.18

(57) ABSTRACT

Introduced is a technology for managing planning items in a calendar user interface based on one or more contingency parameters. In at least some embodiments, the technology involves receiving one or more planning items (e.g., task, appointment, and/or calendar note) and contingency parameters defining each item, and generating different organized presentations of the items based on the contingency parameters. Based on the parameters, the planning items are filtered and/or arranged chronologically into the different organized presentations to include at least a plan view and an act view. The plan view presents all items (e.g., active items that can be acted upon and inactive items that are planned, but not yet to be acted upon), and can be useful, e.g., for organizing short and long-term goals. The act view presents a filtered list of items (e.g., active items) that can be useful, e.g., to present only actionable items.

### CROSS-REFERENCE TO RELATED APPLICATION

This application claims the benefit of U.S. Provisional Patent Application No. 61/899,051 entitled “CONTINGENCY-BASED TASK MANAGEMENT” and filed on Nov. 1, 2013. The contents of which is expressly incorporated by reference herein.

### BACKGROUND

A variety of electronic application solutions exist to assist individuals in planning and organizing their day-to-day lives. In one example, electronic calendar applications allow an individual to create, store, organize, and view meeting appointments. In another example, electronic task management applications allow the individual to create, store, organize, and view various tasks that must be completed or are desired to be completed in accordance with a variety of timing schedules.

Despite the availability of these existing solutions, however, no particular system efficiently integrates the appointment functionality (e.g., time-specific calendar items) with the task functionality (e.g., non-time specific calendar items). Further, the important (or upcoming) meetings, appointments, or tasks often get buried among the entire listing of activities contained within a calendar.

### BRIEF DESCRIPTION OF THE DRAWINGS

One or more embodiments of the technology introduced here are illustrated by way of example and are not limited by the figures of the accompanying drawings, in which like references indicate similar elements.

FIG. 1 illustrates a network-based environment in which one or more embodiments of the technology may be utilized.

FIG. 2 illustrates various components of a system that may be used in accordance with one or more embodiments of the technology.

FIGS. 3A-3C respectively illustrate processes for organizing planning items in accordance with various embodiments of the technology.

FIGS. 4A-4C illustrate example graphical user interfaces associated with various view panes of the Calendar App.

FIGS. 5A-5D illustrate example graphical user interfaces associated with a task item of the Calendar App.

FIG. 6 illustrates an example graphical user interface associated with an appointment item of the Calendar App.

FIG. 7 illustrates an example graphical user interface associated with a calendar note item of the Calendar App.

FIGS. 8A-8B illustrate example graphical user interfaces associated with a checklist creation in the Calendar App.

FIGS. 9A-9D illustrate example graphical user interfaces associated with a project creation in the Calendar App.

FIGS. 10A-10B illustrate example graphical user interfaces associated with categorizing a task and/or an appointment item of a created project in the Calendar App.

FIG. 11 illustrates a block diagram of an architecture for a system that may be utilized to implement the techniques described herein.

### DETAILED DESCRIPTION

Before advancing to discussion of embodiments of the technology introduced here, it may be advantageous to set forth definitions of certain words and phrases used throughout the specification:

A “task” refers to any data item which does not need to be acted upon at a specific, scheduled time, but which a user may desire to perform, or act upon, and complete at some unspecified time before the end of a certain date, before a certain fixed time on a certain date, or even by an inexplicit future time (e.g., “someday”). As used throughout the specification, the term “task” may be used interchangeably with other terms including, but not limited to, “to-do item,” “list item,” “action,” “action item,” “flexible action,” “goal” and “target,” without any intended change in meaning.

An “appointment” refers to any data item that takes place or is acted upon starting at a fixed, scheduled time. As used throughout the specification, the term “task” may be used interchangeably with other terms including, but not limited to, “event,” “fixed-time event,” “timed event,” “date,” “scheduled event,” “calendar item” and “schedule item,” without any intended change in meaning.

A “calendar note” refers to any data item that references event occurrences on a date, or a range of dates, in a calendar, where these event occurrences are not scheduled or defined specifically as actionable items. An example of a calendar note is an item that references a person's birthday on a certain date, without referencing a specific actionable task or an appointment related to the birthday. As used throughout the specification, the term “calendar note” may be used interchangeably with other terms including, but not limited to, “all-day event,” “schedule note,” “date note,” “planning note” and “planning item,” without any intended change in meaning.

A “planning item” refers to any of the task, appointment, and calendar note data items, where the term “planning item” references any data item for planning, or organizing, a user's daily routine and/or life.

An “item name” refers to a name given to a planning item to reference the planning item. The item name can be assigned by a user or by an operator or administrator of a calendar system (e.g., a default item name if no name is assigned).

An “item date” refers to a default date for which a planning item is assigned. The item date differs for each planning item based on the planning item type. For example, an item date of a task refers to the date by which a user has targeted to complete the task or the date on which the task becomes due and needs to be completed. In another example, an item date of an appointment refers to the date on which the appointment is scheduled to occur. In yet another example, an item date of a calendar note is the date to which the calendar note refers. In some embodiments, a list of planning items can be listed in a chronological order based on the item date of each planning item.

An “inactive item” refers to any planning item that is not currently actionable, but is expected (e.g., by a user for purposes of planning) to become actionable and should be acted upon at some point in the future prior to the end of the Item Date. A planning item may be inactive because, for example, a user is waiting for materials needed to complete the planning item, the user is waiting for an appropriate time to contact or follow up with another entity involved in the completion of the planning item, the user has consciously chosen to set the planning item aside for a period of time, the planning item is intrinsically not one that can be acted upon, or for any other causes that render the item non-actionable at the current time.

An “active item” refers to any planning item that is currently actionable; that is, the planning item may be selected by a user to act upon at the current time. An active item, for example, is a planning item that has a deadline in three days from the current date, and is not yet completed by the user, but which has no barriers which would currently prevent the user from acting upon it at a time of the user's choosing.

An “active date” refers to a date from which a planning item becomes actionable, and thus becomes a valid candidate to be acted upon by the user. An active date is valid when it is within the range extending from the current date to the item date of a planning item. The active date is assigned to the planning item by the user, or assigned or implied by a logic that determines active dates for certain types of planning items (e.g., appointment items). In some embodiments, a planning item may not have an active date assigned to the item. For example, for a calendar note type item, which is non-actionable, no active date is assigned. does not have an active date. In another example, for an appointment type item, which cannot be acted upon until the date of the appointment, an active date equal to the item date may be assigned to the appointment by default. In this example, a user may not be allowed to assign an active date to the appointment item.

A “Plan View” refers to a modal view that displays all incomplete items, including both inactive and active items, so as to present all planning items to assist a user in planning.

An “Act View” refers to a modal view that filters out inactive items from all planning items to display only the active, incomplete items, so as to eliminate distractions and present only items that can be acted upon by a user at the present time.

A “Done View” refers to a modal view that filters planning items to display only the completed, or acted upon, items.

A “user” refers to any entity (e.g., an individual) capable of utilizing a calendar planning mechanism (e.g., the introduced technology) to facilitate the organization of the user's short-term and long-term goals (e.g., tasks, appointments, calendar notes, projects, checklists, etc.). In some embodiments, the user may be able to use an electronic device (e.g., a smartphone, a computing tablet, a desktop computer, a laptop, etc.) to access the calendar planning mechanism. In some embodiments, the user may also be able to set up one or more policies associated with various planning items in facilitating the organization.

The terms in the definitions above are used to facilitate understanding through a consistent set of terminology that applies specifically to the current discussion. This is not intended to limit the scope of the technology introduced here, and alternate terms may be used in the construction of various techniques of the technology discussed, as long as their meanings are similar.

Further, references in this specification to “an embodiment,” “one embodiment,” or the like mean that the particular feature, structure, or characteristic being described is included in at least one embodiment of the technology. Occurrences of such phrases in this specification do not necessarily all refer to the same embodiment.

Introduced here is a technology for providing a calendar mechanism that organizes a user's planning items based on one or more contingency parameters (hereinafter, “the technology”). In at least some embodiments, the technology involves communication between a mobile calendar application (hereinafter, “Calendar App”), installed on the user's mobile device, where the Calendar App is facilitated by a calendar management server system (hereinafter, “CMSS”). The Calendar App enables the user to submit, or input, one or more planning items and their associated contingency parameters, organizes the planning items into separate listings by using the contingency parameters, and displays for the user the items of each separate listing in a chronological order as defined by the contingency parameters (e.g., item type, active date, etc.). The contingency parameters can include, but are not limited to, an item type (e.g., task item, appointment item, and/or calendar note item), an item date, a tag, and/or a project assignment.

The technology introduced here makes managing the planning items relatively quick and easy compared to conventional systems and methods. A user merely has to submit the planning items and associated parameters, and the items are automatically organized and logically displayed to the user, without any further user inputs. Further, the chronological organization (and display) of the planning items can provide an automatic filtering of irrelevant items, thereby conveniently eliminating distraction and allowing the user to efficiently accomplish short-term and long-term goals. The user will only see, for example, planning items that the user can act upon, or perform, thereby increasing the focus on relevant items.

Accordingly, some embodiments of the disclosed technology envision a calendar system that organizes planning items (e.g., tasks, appointments, and/or calendar notes) into a PLAN view, which displays all planning items, and an ACT view, which displays all task planning items and appointment items (of today), without any calendar note items. Some embodiments of the disclosed technology envision that the calendar note items are displayed within the ACT view based on a policy. The policy can be configured by a user or a system administrator. Some embodiments of the disclosed technology envision that the appointment items displayed within the ACT view are displayed at midnight of the day that precedes the appointment or 8 hours before the appointment, whichever comes first. Note that other algorithms, or logic, for when to display the appointments in the ACT view are possible. For example, the logic can be based on a policy that is configured by a user or a system administrator. Some embodiments of the disclosed technology envision a calendar system that organizes planning items so that a user can only see those task planning items that are active (i.e., active task items) based on an active date set by the user. Some embodiments of the disclosed technology envision a calendar system that organizes the planning items in the PLAN view to display only some items based on a policy. The policy can be configured by a user or a system administrator. For example, the policy can specify that the PLAN view displays only items for the next two years.

Consider an example scenario where a user utilizes a mobile device, such as a smartphone, to access the Calendar App. The user submits planning items “A,” “B,” and “C” through a user interface of the Calendar App. For each item, the user can also submit contingency parameters. Example contingency parameters for the three items are as follows:

| Item Name | Item Type | Item date | Tag | Project |
|---|---|---|---|---|
| Item A | Task | Jul. 1, 2014 | Errands | No |
| Item B | Appointment | Aug. 1, 2014 | Work | Yes |
| Item C | Calendar Note | Sep. 1, 2014 | Home | No |

In some embodiments, the contingency parameters include user-defined or user-specified parameters, default parameters that are defined or specified by an operator or administrator of the CMSS, or a combination thereof. For example, the user can leave the item date empty (i.e., does not submit a value), and the Calendar App will automatically assign a default item date of “today” (i.e., the current date), as specified by the CMSS in the scenario that no value is submitted.

In response to the submitted planning items and one or more contingency parameters for each of the planning items, the Calendar App analyzes the contingency parameters and organizes them into separate listings, or subsets of one or more planning items. In some embodiments, the separate listings can include a listing of all items (i.e., inactive items and active items), a listing of all active items, and a listing of all completed, or acted upon, items. In some embodiments, the listing of completed items may not have any item listed (e.g., the user has not completed any planning item). For example, if the current date is June 1, and that Item A does not have an active date that would cause it to be categorized as inactive, the listing of active items would only include Item A, and the user would not be distracted by the display of Items B and C when viewing that listing. In this example, Items B and C are planning items that, based on their respective item types, cannot be acted upon at the current time. In some embodiments, the Calendar App chronologically organizes the items in each separate listing according to the item dates and displays a chronological listing to the user. For example, assuming Items A-C differ by one day (e.g., June 1, June 2, June 3), the listing of all items will display the item with the “June 1” item date first, and the item with the “June 3” item date last.

In some embodiments, in response to the submitted planning items (and associated parameters), the Calendar App also determines whether to organize Items A-C according to project assignments. The term “project assignment” as used here refers to a particular planning item being assigned as a “project” by a user. The assignment can be carried out by either (a) converting the planning item into a project, under which other planning items can be organized or grouped under the project, or (b) categorizing the planning item as a member of a project so created. An example of categorizing the planning item as a member of a project is a scenario where the user submits a value for a contingency parameter to indicate that an Item B is a planning item of a project X (e.g., Project X contains Item B).

An example of converting a planning item into a project is a scenario where the user submits a value for a contingency parameter to indicate that an Item B is a project (e.g., Project “Item B”). In response, the Calendar App organizes Item B as a project and enables the user to associate additional planning items with that project. For example, the user can associate, or assign, Item A as a planning item to be included in, or categorized under, the project “Item B.” In some embodiments, the listing of all items may be updated in response to the assignment of Item B as a project. For example, Item A, which has been assigned to project “Item B” may be displayed with an indicator indicating that Item A is a planning item belonging to that project. Such dual display (as a project and a planning item within a project), is advantageous in that it allows the user to view the individual item date of Item A along with the item date of the project as a whole, in contrast to conventional calendar systems and methods that only allow viewing, and organization, of only one item date.

In some embodiments, a user can utilize the Calendar App to create a project without having to convert from an existing planning item. That is, in such embodiments, the user can create, for example, a “Project Fix Bicycle” without having to first create, e.g., a task item or calendar note item “Fix Bicycle” and subsequently converting that into a project. In these embodiments, a project operates as a Tag that the user can assign to the project in order to group items together.

In some embodiments, the Calendar App assists the user to further manage a task item by having subtasks. For example, the user can specify that task Item C includes sub-tasks that must be completed to fully complete task Item C. In some embodiments, the sub-tasks can be in the form of a checklist. In such embodiments, the checklist can include “sub-tasks” that can be generally completed at a similar time as the task for which the checklist has been created. Example sub-tasks can include shopping items (e.g., for a shopping list), simple procedures (e.g., for performing a task), discussion agenda, etc.

In some embodiments, the Calendar App allows the user to further manage a planning item by enabling the user to assign an active date to the planning item. In such embodiments, the Calendar App updates one or more listings containing that planning item when it receives an active date for a particular planning item. On one hand, a planning item that does not have an active date (e.g., assigned by the user) remains active. On the other hand, a planning item assigned with an active date, can have a time period of inactiveness (i.e., the item is inactive) and a time period of activeness (i.e., the item is active). The time period, or range, of inactiveness extends from the current date until the assigned active date. The time period, or range, of activeness extends from the assigned active date into a future date (e.g., the item date or the date of completion). The period of activeness can be visually expressed as follows:

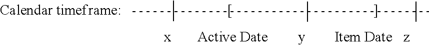

In the visually expressed calendar timeframe above, if the current date is at point “x,” then the planning item is inactive, and remains inactive until the “Active Date.” If the current date is at point “y,” then the planning item is active. If the current date is at point “z,” and the planning item has not yet been completed, then the planning item remains active until completion.

Consider the following example of an Item A that has an item date of July 1. In the example, certain real-life circumstances may dictate that a user cannot work on Item A until June 25. In such example, the user can account for the real-life circumstances by submitting an active date of “June 25” to the Calendar App to indicate that Item A is constrained by this newly submitted date (i.e., “the active date”) and is only actionable upon June 25 or after. In response to receiving the active date, the Calendar App determines whether to remove Item A from the listing of active items.

If a planning item has an active date, then that item is inactive, or non-actionable, until the current date corresponds to, or becomes, the active date. For example, if the current date is June 20, the Calendar App removes Item A from the listing of active items. In such example, the Calendar App automatically updates the listing to add back Item A at a subsequent day when the current date becomes June 25. In some embodiments, the Calendar App, in response to the receiving the active date, updates a timeline associated with the planning item to reflect the received active date. In such embodiments, the timeline can be displayed visually on the Calendar App for viewing by the user.

In some embodiments, the Calendar App is configured to receive an active date for only certain types of planning items. For example, the Calendar App is configured to receive an active date only for task items. In another example, the Calendar App is configured to disable the active date for calendar notes, as calendar notes are non-actionable by their nature. In yet another example, the Calendar App is configured to assign the appointment date as the default active date for an appointment, as appointments can often be considered to have an intrinsic characteristic of becoming actionable on the appointment dates.

In some embodiments, the active date is received from the Calendar App. In such embodiments, the active date is automatically assigned to a particular planning item based on the item type. The item type can be, for example, an appointment type. In such example, the item date of the appointment item is automatically assigned as the active date. The logic behind such assignment is that appointments can often be considered to have an intrinsic characteristic of becoming actionable on the appointment date. Based on the assignment of the item date, the appointment item can remain as an inactive item until the active date, which is the item date of the appointment item. As an inactive item, the appointment item is removed from the ACT view, eliminating the calendar clutter on behalf of the user.

Note, that while a user generally uses a mobile device to organize, plan, and access calendar information associated with the various planning items in the embodiments emphasized here, in other embodiments the user may use a processing device other than a mobile device, such as a conventional personal computer (PC). In such embodiments, the mobile calendar application can be replaced by a more conventional software application in such processing device, where such software application has functionality similar to that of the mobile calendar application as described here.

Other features and advantages of the technology introduced here will become more apparent from the description to follow, taken in conjunction with the accompanying drawings.

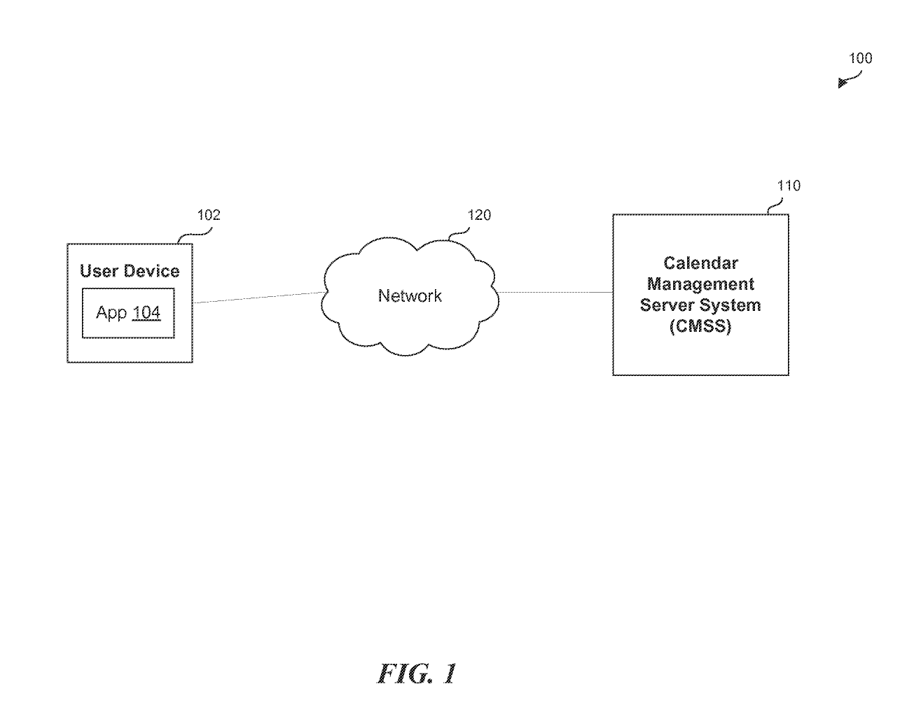

FIG. 1 illustrates a network-based environment 100 in which one or more embodiments of the technology may be utilized. The environment 100 includes one or more user devices 102 connected to a calendar management server system 110 (or CMSS 110) via a network 120. Note that the environment 100 is only an example environment in accordance with the technology introduced herein.

The user device 102 can be any general-purpose computing device capable of data processing. The user device 102 may be, for example, a smartphone (e.g., iPhone®, Android®-based phone, etc.), a tablet (e.g., iPad®, Galaxy Tab®, etc.), a personal digital assistant (PDA), an e-reader, a desktop, a laptop, or other wired and wireless personal computers or portable computing devices. The user device 102 can embody a user application 104 (hereinafter “App 104”), such as the Calendar App, for use by a user of the user device 102 to create, organize, and plan short-term and long-term goals, such as tasks, appointments, and/or calendar notes. In some embodiments, the App 104 can assist the user to organize and plan for one or more projects that include any tasks, appointments, and/or calendar notes. In some embodiments, the App 104 can assist the user to add a checklist, or a list of “subtasks,” to any task or appointment. The user device 102 can include a display (not shown) for displaying various user interfaces to enable a user to interact with content generated by the App 104.

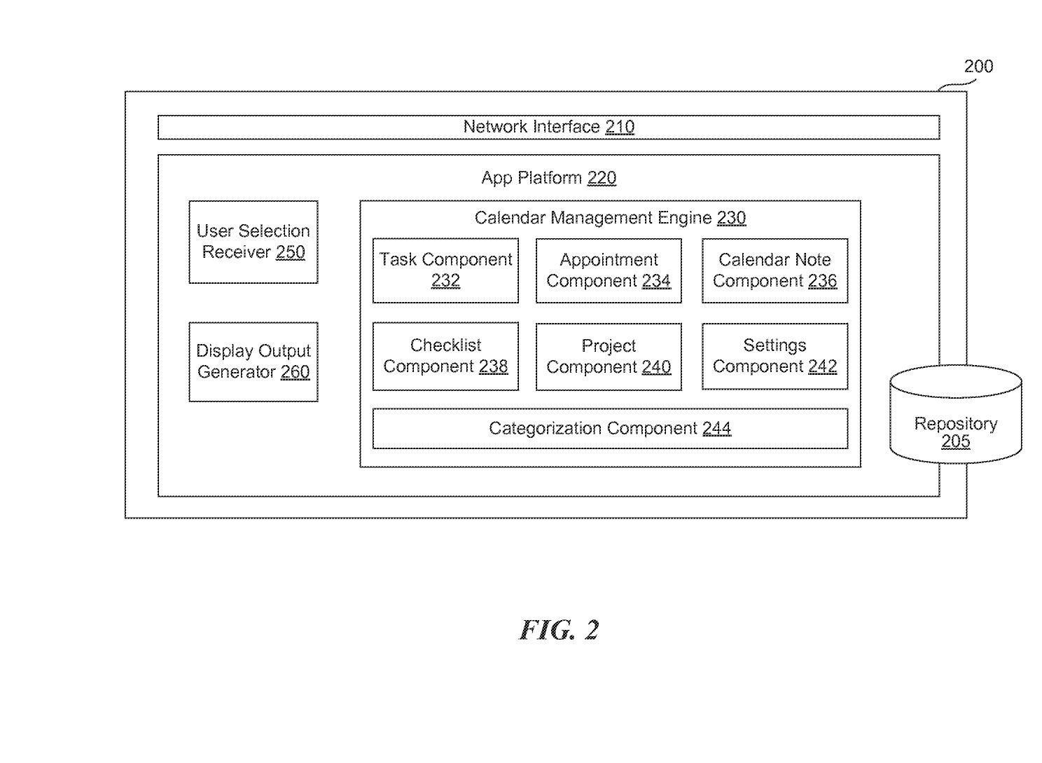

The CMSS 110 may be one or more server computers or work stations that are employed by a company for hosting and/or facilitating a mobile calendar application that functions as a mechanism for a user to organize and plan tasks, appointments, calendar notes, and any other short-term and long-term goals. The CMSS 110 typically includes at least one processor and a memory, and may be further connected to one or more computers (not shown in FIG. 1 for simplicity) that manage data, calendar-related parameters, and/or other calendar functions via the network 120. The CMSS 110 is also typically equipped with or is coupled to a repository (e.g., repository 205, discussed below in relation to FIG. 2) for storing the parameters that define each planning item submitted to the App 104, calendar information related to the planning items (e.g., tasks, appointments, calendar notes, checklists, and/or projects), and/or data for facilitating the Calendar App that manages the organizing and planning. The repository can include, for example, one or more hard drives (which may be further coupled together using RAID-0, 1, 5, 10, etc.), a centralized or distributed data cluster, a cloud-storage service provider, or other suitable storage systems suitable for storing digital data.

Furthermore, although the CMSS 130 is illustrated in FIG. 1 (as well as described throughout the present disclosure) as a separate entity from the user device 102, it is noted that in some specific embodiments, both the user device 102 and the CMSS 130 can be implemented in the same computing device, such as a smartphone or a tablet computer so that the standalone computing device can be the sole host of the environment 100 and practice the various techniques of the technology disclosed here.

The network 120 is configured to enable communications between various network entities, such as the user device(s) 102 and the CMSS 110. The network 120 may be a communication network based on certain communication protocols, such as TCP/IP protocol. Such network may include, but is not limited to, Internet, Intranet, wide area network (WAN), local area network (LAN), wireless network, Bluetooth, WiFi, and mobile communication network. The physical connections of the network and the communication protocols are well known to those of skill in the art.

FIG. 2 illustrates various components of a system 200 that that may be used to implement the introduced technology in accordance with one or more embodiments. In one embodiment, the system 200 can be the CMSS 110 of FIG. 1. According to an embodiment, the system 200 includes a repository 205, a network interface 210, and a calendar application platform 220 (hereinafter, “Calendar Platform 220”). One or more embodiments of the Calendar Platform 220 can include a calendar management engine 230, a user selection receiver component 250, and a display output generator component 260. In implementing the technology introduced herein, the calendar management engine 230 can include a task component 232, an appointment component 234, a calendar note component 236, a checklist component 238, a project management component 240, a settings component 242, and a categorization component 244.

The repository 205 functions similarly to the repository discussed with respect to FIG. 1. The repository 205 can be used for storing the contingency parameters, calendar information related to the planning items, and/or data for facilitating the Calendar App that manages the organizing and planning. The repository can include, for example, one or more hard drives, a centralized or distributed data cluster, a cloud-storage service provider, or other suitable storage systems suitable for storing digital data.

The user selection receiver component 250 can detect or receive a user's selection or input from a user's device (e.g., device 102 of FIG. 1) (e.g., via an input device coupled to the device 102 such as a mouse, a keyboard, a touchscreen, an actuatable button, a gesture capturing device, a microphone, or the like). The component 250 is coupled to the calendar management engine 230 in communicating the user's selection/input.

The display output generator module 260 can generate, adjust, modify, replace, or edit the content of a graphical user interface (e.g., as displayed on the device 102) of the Calendar Platform 220. For example, the display output generator module 260 can include program codes that generate or adjust data to display or adjust the formatted content on one or more view panes (e.g., in forming the graphical user interface) on the screen of the device 102.

The network interface 210 can be a networking component that enables the system 200 to mediate data in a network with an entity that is external to the system 200, through any known and/or convenient communications protocol supported by the host and the external entity. The network interface 210 can include one or more of a network adaptor card, a wireless network interface card (e.g., SMS interface, WiFi interface, interfaces for various generations of mobile communication standards including but not limited to 1G, 2G, 3G, 3.5G, 4G, LTE, etc.,), Bluetooth, a router, an access point, a wireless router, a switch, a multilayer switch, a protocol converter, a gateway, a bridge, bridge router, a hub, a digital media receiver, and/or a repeater.

The embodiments of the technology introduced here recognize that aforementioned existing techniques do not adequately address the need of organizing and planning short and long-term goals of a user in a calendar framework, so as to allow a user to focus and efficiently organize tasks, appointments, calendar notes, checklists, and/or projects.

Accordingly, the Calendar Platform 220 includes the capabilities to provide a more natural, focused, and efficient way to organize planning items in a calendar framework. It is recognized by the present disclosure that, from a calendar organization standpoint, there are typically certain planning items that are more “urgent” to a user (e.g., that require the user's immediate attention), that the user may not necessarily remember or know how urgent is each of those items, and that the user often finds herself staring at an overwhelming list of these items that may or may not really be actionable, as she may not be able to do anything about some of those items at the present moment (e.g., a task cannot be completed until another event occurs). The embodiments of the Calendar Platform 220 can manage the planning items on behalf of the user without requiring the user to laboriously update the “actionable” statuses of the planning items, and without having to mentally analyze each item to determine if it is actionable and can be productively worked on. The Calendar Platform automatically organizes one or more planning items submitted by a user according to a chronological order, and updates the order whenever there is any new contingency parameter(s) that affect the planning of those items.

More specifically, in some embodiments, the Calendar Platform 220 receives, from the user directly, one or more planning items and one or more contingency parameters that define the planning items through the user selection receiver component 250, and stores them in the repository 205. In some embodiments, the planning items and contingency parameters can be received indirectly (e.g., through the network interface 210 communicating with Apple® iCloud®, Microsoft® Outlook®, or any other third party calendar system). In some embodiments, the contingency parameters can be received from an application executed by the Calendar Platform 220 (e.g., application generated default parameter values).

Next, the planning items and contingency parameters are sent to the calendar management engine 230 for further processing. The task component 232, the appointment component 234, and the calendar note component 236 of the calendar management engine 230 handles, respectively, the planning items based the item type, which is defined by the contingency parameters of each item. Each of the components 232, 234, 236 works in coordination with the categorization component 244 to categorize their respective planning item as an active or inactive item. The categorization component 244 determines the “active” status of the planning item (i.e., active data item or inactive data item). In some embodiments, the categorization component 244 determines the active status based on the item type. In some embodiments, the categorization component 244 makes such determination based on the item date of the item. In some embodiments, the categorization component 244 makes the determination based on both the item type and the item date.

The active status is used to filter the planning items for presentation in separate view panes to the user. For example, active items, once identified by the categorization component 244, are sent to the display output generator module 260. The display output generator module 260 can generate a view pane to display to the user those active items, separate from inactive items and/or completed items, thereby removing the distraction of items that do not require the user's immediate attention when looking at that view pane (i.e., items that are not actionable). The separation of active and inactive items enables automatic organization of items to provide the user a more natural, focused, and efficient calendar planning experience than traditional techniques.

In some embodiments, the user is able to further plan short and long-term goals by adding checklists to any of the task, appointment, and/or calendar note items. In such embodiments, the checklist component 238 works in coordination with each of the components 232, 234, 236 to facilitate management of the checklist for any task, appointment, or calendar note. In some embodiments, the user is able to further plan the short and long-term goals by associating the tasks, appointments, and/or calendar notes with one or more projects. In such embodiments, the project component 240 works in coordination with each of the components 232, 234, 236 to facilitate management of the project for any task, appointment, or calendar note. Further details of various embodiments of the technology will be discussed below.

The settings component 242 allows the user to submit inputs to change any of the contingency parameters of a planning item. For example, the settings component 242 facilitates generation of a user interface to enable the user to change and/or add a contingency parameter, including, for example, an item name, an item type, an item date, an active date indicating when the item may be acted upon, a detailed note, a tag, and a project assignment, among others. Changes to, or additions of, one or more contingency parameters are received by the calendar management engine 230 to further process the affected planning item(s). For example, in a scenario where a user changes the item date for an appointment (i.e., a new appointment date and time) from today to two weeks from today, the appointment component 234 of the calendar management engine 230 receives such change and updates the appointment accordingly. Such update can include, for example, communicating with the categorization component 244 so that the categorization component 244 could re-categorize the appointment item as inactive for today, when it has been formerly active.

Each of the blocks, components, engines, and/or modules associated with the system 200 may be implemented in the form of special-purpose circuitry, or in the form of one or more programmable processors that are programmed to provide the functionality described above, or in a combination of such forms. For example, the components described can be implemented as instructions on a tangible storage memory capable of being executed by a processor or a controller on a machine. The tangible storage memory can be a volatile or a non-volatile memory. In some embodiments, the volatile memory can be considered “non-transitory” in the sense that it is not a transitory signal. The blocks, components, engines, and/or modules can be operable when executed by a processor or other computing device, e.g., a single board chip, application specific integrated circuit, a field programmable field array, a network capable computing device, a virtual machine terminal device, a cloud-based computing terminal device, or any combination thereof.

Each of the blocks, components, engines, and/or modules can operate individually and independently of other blocks, components, engines, and/or modules. Some or all of the blocks, components, engines, and/or modules can be executed on the same host device or on separate devices. The separate devices can be coupled via a communication module to coordinate its operations via an interconnect or wirelessly. Some or all of the blocks, components, engines, and/or modules can be combined as one block, component, engine, and/or module.

For example, a single module can also be divided into sub-modules, each sub-module performing separate method step or method steps of the single module. In some embodiments, the blocks, components, engines, and/or modules can share access to a memory space. For example, one module can access data accessed by or transformed by another module. The blocks, components, engines, and/or modules can be considered “coupled” to one another if they share a physical connection or a virtual connection, directly or indirectly, allowing data accessed or modified from, e.g., one module, to be accessed in, e.g., another module. In some embodiments, some or all of the, e.g., modules, can be upgraded or modified remotely. The system 200 can include additional, fewer, or different blocks, components, engines, and/or modules for various applications.

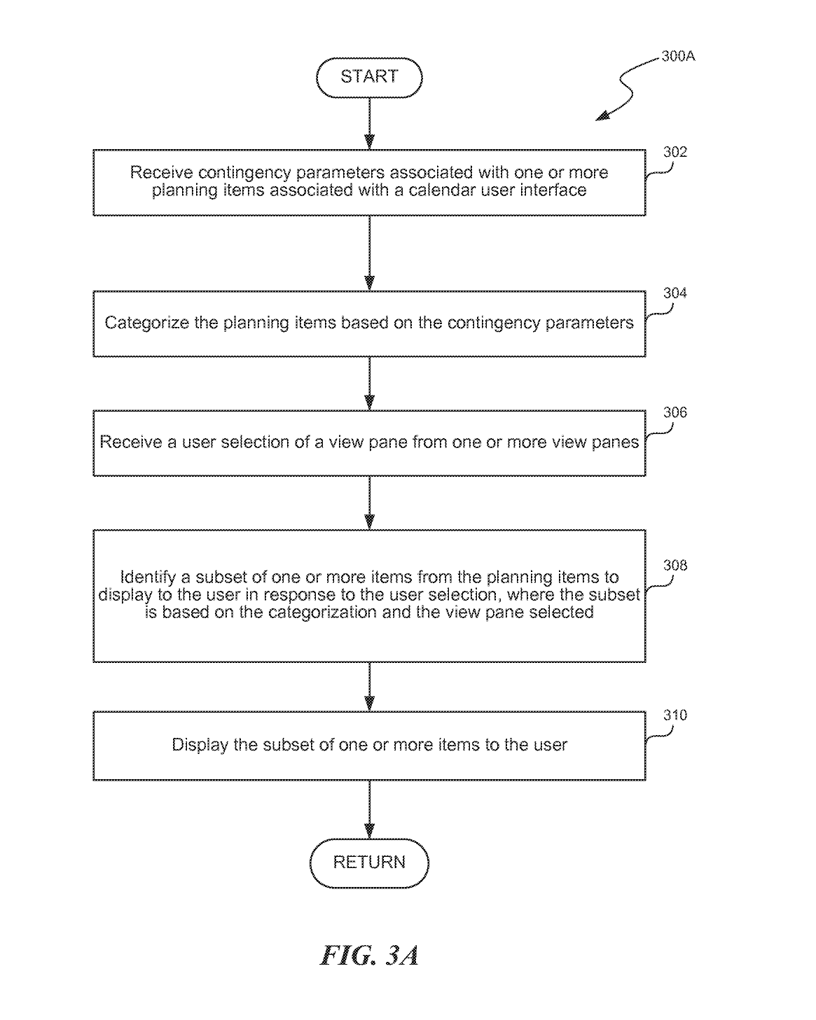

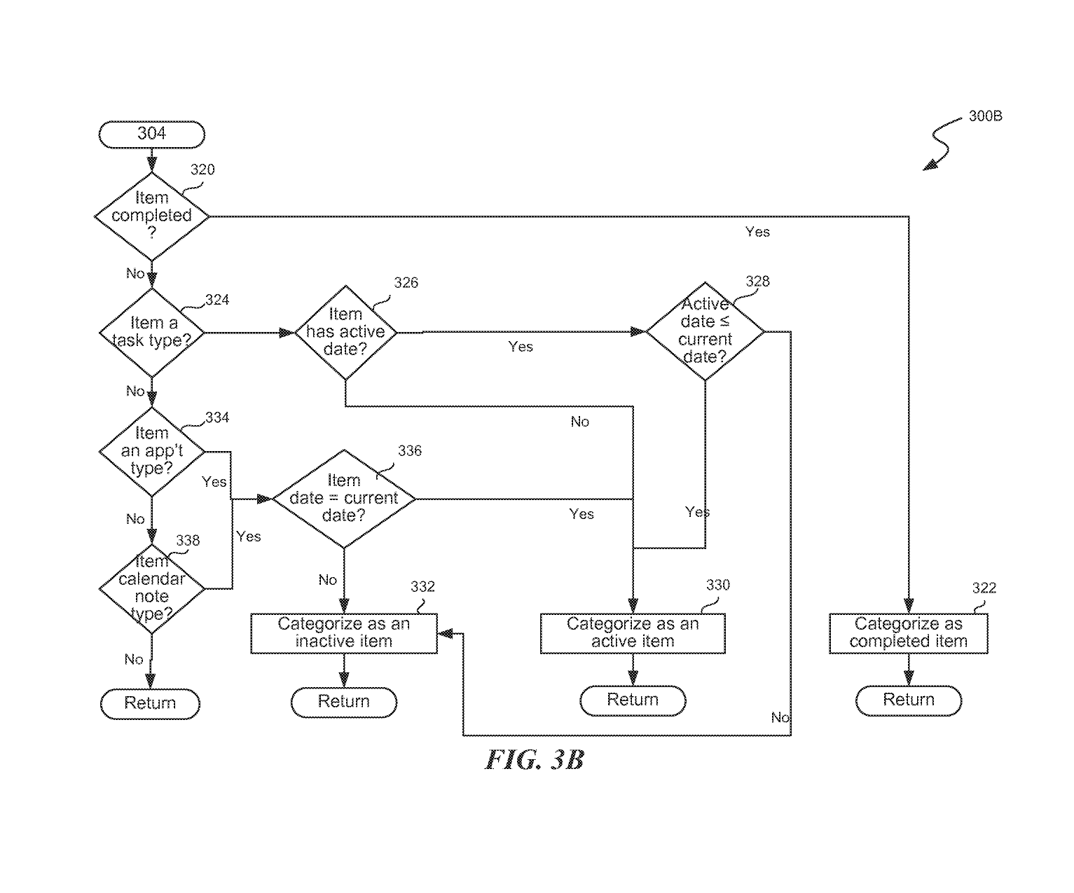

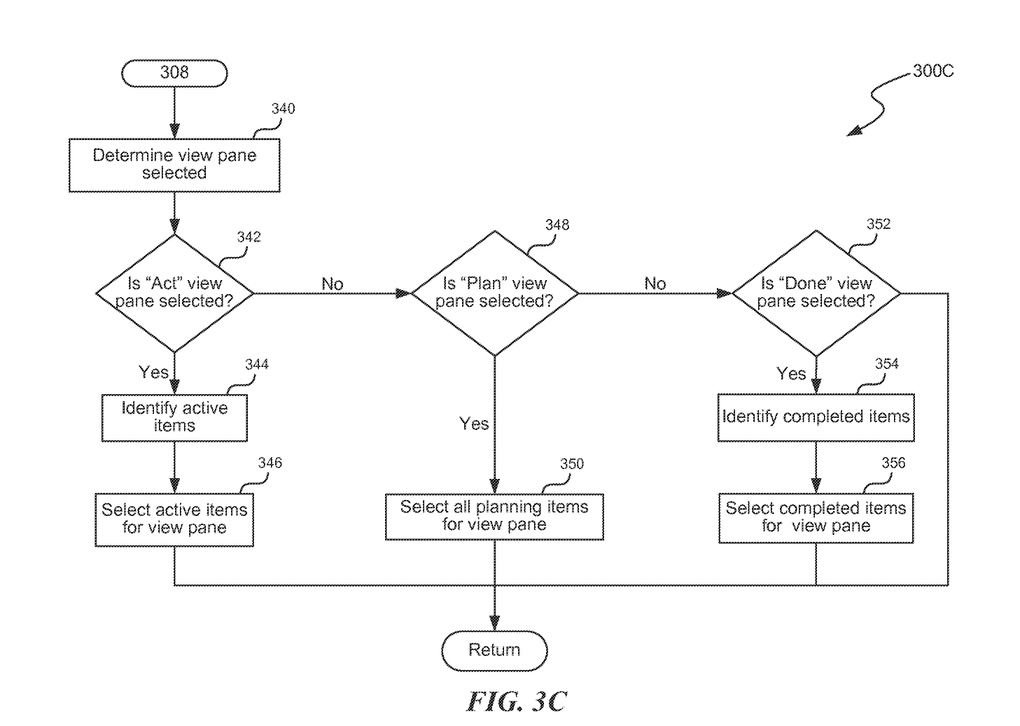

FIGS. 3A-3C respectively illustrate processes 300A, 300B, and 300C for organizing planning items in accordance with various embodiments of the technology. The processes 300A, 300B, 300C may be performed, for example, in the network-based environment 100 by the CMSS 130 of FIG. 1 or the system 200 of FIG. 2.

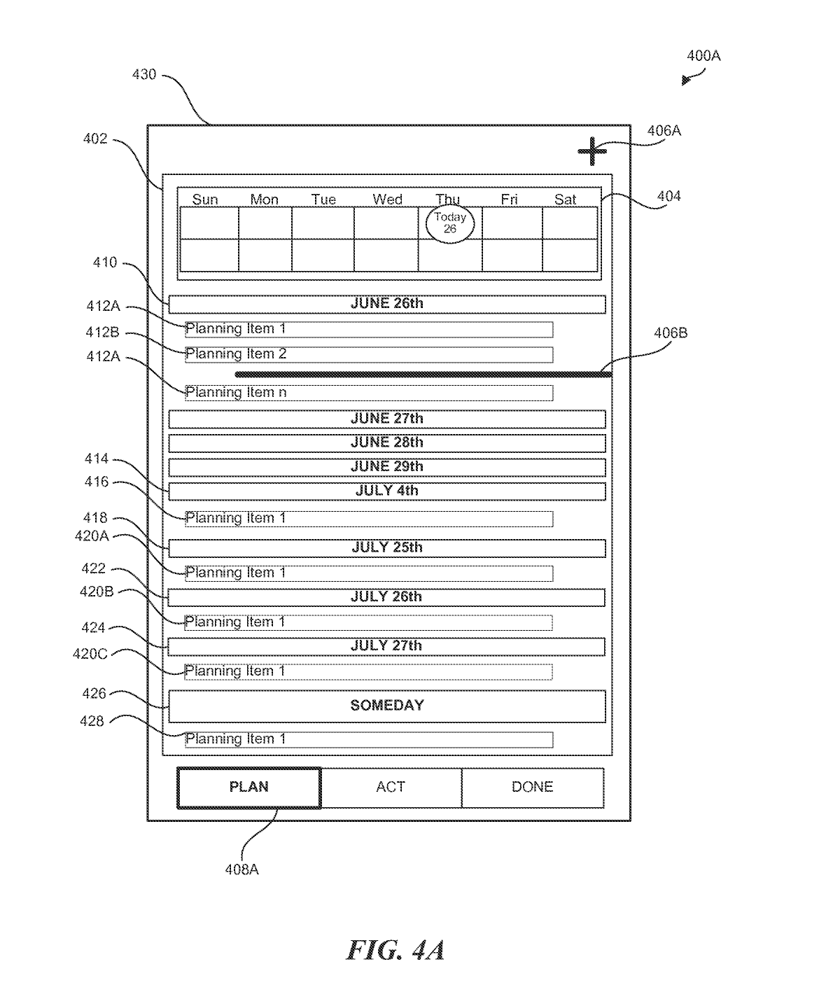

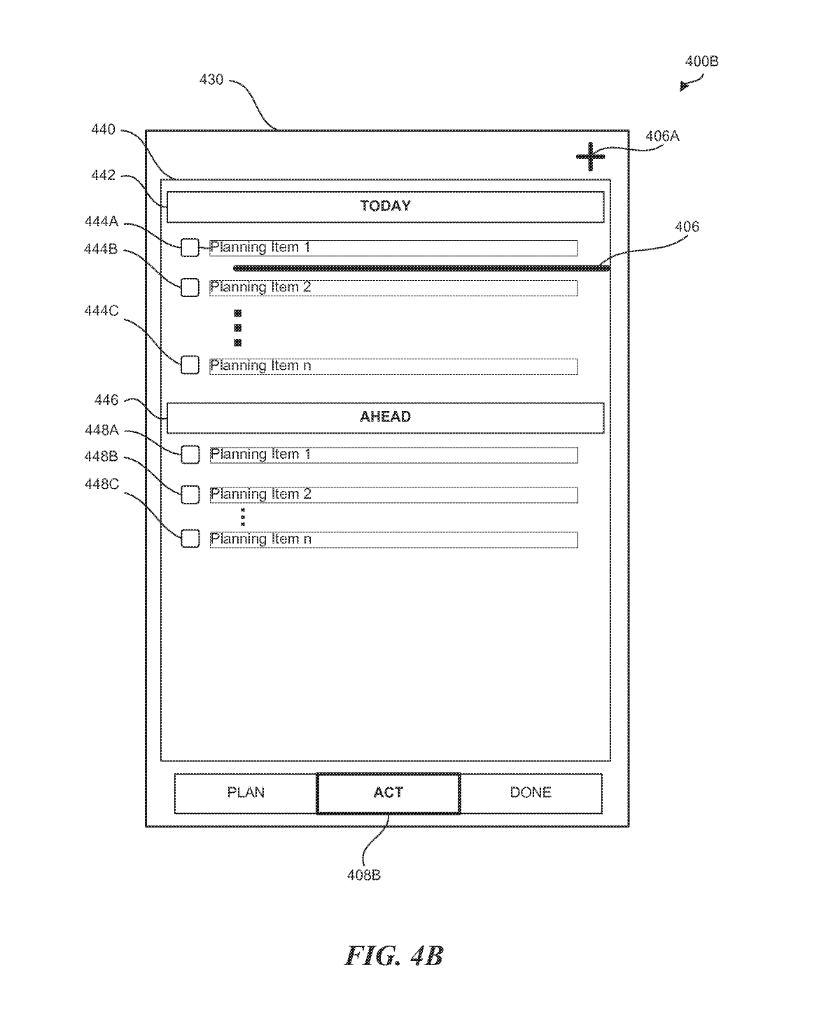

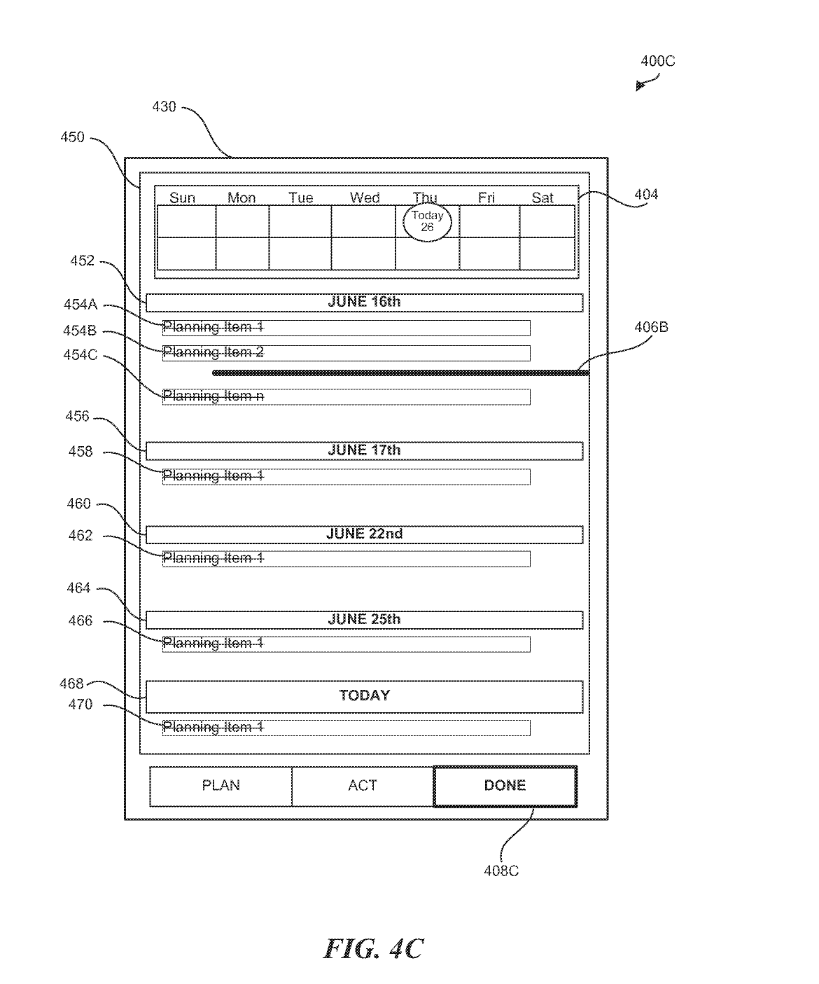

FIG. 3A illustrates the process 300A in accordance with an embodiment of the technology for organizing one or more planning items in a calendar framework, such as a calendar user interface of a calendar application (e.g., App 104 of FIG. 1 or Calendar Platform 220 of FIG. 2) executing on a user device (e.g., user device 102 of FIG. 1) and facilitated by a calendar system (e.g., CMSS 110 or system 200). For the sake of simplicity, the following description of FIG. 3 will refer to the system 200 executing the process 300A. Further, to facilitate ease of understanding, the following description will be discussed in conjunction with one or more graphical user interfaces illustrated in FIGS. 4A-4C; this is not intended to be limiting in any way. Last, while the process 300A is described in relation to more than one planning items, the process 300A can be executed for just one planning item.

The process 300A starts at step 302 when the system 200 receives a set of contingency parameters associated with a set of planning items. The set of contingency parameters can be received from a user and/or the calendar application that executes the calendar framework. For example, the user can submit one or more contingency parameters through the user selection receiver 250 of FIG. 2 of the Calendar Platform 220, or through another input device and/or module of a third party calendar system that is in communication with the system 200 (e.g., through the network interface 210). In this example, additional one or more contingency parameters of the set can be generated by the calendar application itself. For example, the calendar application generates a default item date of “Today” if the user does not submit an item date.

As used here, the “set” of contingency parameters refers to an atomic set of one or more parameters that can include a planning item type, a planning item name, a planning item's item date, a detailed note of a planning item, a tag, a project assignment, a repeat option, an item status (e.g., active, inactive, or completed), and/or any other parameter that defines the planning item. A set of contingency parameters can define a planning item within the calendar framework. For example, a planning item is defined by the type “task,” by the name “Fix Bicycle,” by the item date of end of the month, e.g., “July 31,” by a tag “Hobbies,” and by a project assignment “Triathlon.” As illustrated in this example, a planning item may have one or more, and does not necessarily have all of the contingency parameters (e.g., no detailed note and no repeat).

In some embodiments, the set of contingency parameters also includes an active date that defines whether a planning item is able to be acted upon (i.e., actionable). In such embodiments, a planning item that has an active date has a status of “active” within a time period of activeness extending from the active date to the item date and/or to a date of completion (e.g., the item is marked as completed by a user). Further, in such embodiments, an item has a status of “inactive” within a time period of inactiveness extending from the current date to the active date. Accordingly, the active date affects how the planning item is treated by the Calendar App for purposes of calendar organization and planning. The active date can operate, for example, as a time constraint assigned to a particular planning item. Further details regarding the “active date” contingency parameter will be discussed with respect to processes 300B and 300C in FIGS. 3B-3C.

As used here, the “set” of planning items refers to an atomic set of one or more planning items of a user utilizing the calendar framework to organize short and/or long-term goals. The short and long-term goals can be structured by having one or more planning items organized based on (i) an item date of a planning item associated with a goal, and (ii) that planning item's item type, including, e.g., a task type, an appointment type, and/or a calendar note type. A short-term goal can be, for example, “to fix my bicycle” and can be structured as a “task” planning item that needs to be acted upon, or completed, by tomorrow (e.g., July 2). That same short-term goal of fixing the bicycle could also be a long-term goal, where it is structured as a “task” planning item that needs to be acted upon six months from today, as opposed to tomorrow. In another example, a short-term goal can be structured, e.g., as an “appointment” planning item indicating an eye-doctor visit for today while a long-term goal can be structured, e.g., a “calendar note” planning item indicating a birthday event a year and two-months from today.

Additional contingency parameters can assist the user in organizing the short and/or long term goals. Examples of these additional contingency parameters include the active date, the detailed note, the tag, the project assignment, and/or the repeat option. The calendar framework assists the user to organize these goals automatically, without much burden from the user, as long as the contingency parameters are provided to the system executing the framework (e.g., App 104, CMSS 110, or system 200).

At step 304, the categorization component 244 of the system 200 categorizes each planning item in the set of planning items based on one or more of the contingency parameters defining each planning item. Additional details regarding step 304 are discussed in FIG. 3B. At step 306, the system 200 receives a selection from a user to view a particular view pane within the calendar framework (e.g., calendar user interface). The calendar framework can have different view panes, such as illustrated in FIGS. 4A, 4B, and 4C. For example, the calendar framework can include a first view pane labeled as a “PLAN” view pane 402 as illustrated in a graphical user interface (GUI) 400A of FIG. 4A, a second view pane labeled as an “ACT” view pane 440 as illustrated in a GUI 400B of FIG. 4B, and a third view pane labeled as a “DONE” view pane 450 as illustrated in a GUI 400C of FIG. 4C. In other embodiments, other equivalent names may be used for the view panes.

Each view pane 402, 440, 450 contains at least a portion of the calendar information associated with the one or more planning items received by the system 200 at step 302. An example portion of the calendar information of a planning item can be the item name and the item date of the planning item. The “PLAN” view pane 402 can include calendar information associated with the planning items received by the system 200. The “ACT” view pane 440 can include calendar information associated with only those one or more planning items that are categorized at step 304 as active items. The “DONE” view pane 450 can include calendar information associated with only those one or more planning items that are completed, i.e., have been acted upon to the point of completion by a user. In some embodiments, a “completed” planning item can be categorized, or assigned with, a completed status at step 304. In some embodiments, the completed item is assigned with the completed status upon the system 200 receiving a user input indicating completion of the item. In such embodiments, the user input can be received through the user selection receiver 250 (e.g., via a mouse, keyboard, touchscreen, microphone, etc.). For example, the user touches a checkbox associated with a planning item on a touchscreen while viewing the planning item in the ACT view pane 440 to indicate completion. In another example, the user submits an input to change a contingency parameter that defines the planning item as completed.

Accordingly, at step 308, the system 200 identifies a set of selected items to display on the view pane selected by the user at step 306. The set of selected items is a subset of the one or more planning items created through receipt of the contingency parameters at step 302, where items in the subset have been selected based on the selected view pane. For example, if the user selects the ACT view pane 440 (of FIG. 4B), then at step 308 the system 200 selects only active items from all of the planning items. In another example, if the user selects the DONE view pane 450 (of FIG. 4C), then at step 308 the system 200 selects only completed items. In yet another example, if the user selects the PLAN view pane 402 (of FIG. 4A), then at step 308 the system 200 selects all of the planning items. At step 310, the system 200, e.g., through the display output generator 260, displays the set of selected items to the user in the view pane selected by the user at step 306. The process 300A ends and returns after step 310.

FIG. 3B illustrates the process 300B that includes details of the step 304 of the process 300A. In some embodiments, the process 300B can be executed by the categorization component 244 of the system 200 of FIG. 2. In some embodiments, the process 300B can be executed by various components of the system 200 of FIG. 2, including the categorization component 244, that work in coordination to execute the steps of the process 300B. For the sake of simplicity, the following discussion refers to the system 200 executing the process 300B. However, such reference is non-limiting and is done for the purposes of facilitating ease of understanding.

At decision step, or block, 320, the system 200 determines whether a particular planning item has been assigned, or marked, as “completed” (i.e., assigned a status of “complete”) in order to categorize the item. Such assignment or marking can be a contingency parameter that defines the particular planning item. The assignment or marking can be a result of the system 200 receiving an input or submission from a user interacting with the Calendar App (e.g., checking a checkbox next to the planning item to indicate completion). If the particular planning item is marked as completed, the system 200 categorizes the item as completed (i.e., status of complete), as indicated in step 322. If the particular planning item is not assigned or marked as completed, the system 200 moves to decision step, or block, 324.

At decision step 324, the system 200 determines an item type, and more particularly, the system 200 determines whether the item being evaluated in the process 300B is a task item. The item type can be determined based on the value of a contingency parameter (e.g., item type parameter) that is, for example, received at step 302 of the process 300A. In some embodiments, the item type can be determined based on a default type assigned automatically, by the system 200 (e.g., by Calendar Platform 220 of FIG. 2 or by the App 104 of FIG. 1), when no value is received by the system 200 (e.g., at step 302 of process 300A). For example, an item is automatically assigned to be a task (i.e., task type) if no specific type is specified by a user. If the planning item being evaluated is of a task type, then the system moves to decision step, or block, 326.

At decision step 326, the system 200 determines whether the task item has an active date assigned to the item (i.e., based on one or more of the contingency parameters of that item). In some embodiments, the active date can be assigned by, or received from, a user to reflect real-life circumstances. In some embodiments, the active date can be assigned by, or received from, an application executing the calendar framework (e.g., the Calendar App) based on a computing logic that reflects predicted real-life circumstances. In one example, the user assigns an active date of Nov. 11, 2014 (where the current date is Sep. 11, 2014) for a task of “Fix Bicycle” to reflect that bicycle parts will arrive on September 11, and as such, the task cannot be started until then. In another example, an appointment item is assigned an active date of the item date (i.e., appointment date) to reflect that in real-life, a user may not need to take action, or pay attention, to the appointment until the appointment date.

As discussed above, a planning item may or may not have an active date. The system can determine whether the item has an active date by looking at the contingency parameters defining the planning item. For example, if a user has assigned an active date for the planning item, the “active date” contingency parameter will provide an “active date” value indicating the active date assigned to the planning item. If the particular planning item has an active date, the system 200 continues to decision step, or block, 328. If the particular planning item has no active date, the system 200 continues to decision step, or block, 330 to categorize the task item as an active item.

At decision step 328, the system 200 determines whether the active date is prior to (i.e., in the past) or equal to the current date. That is, the system 200 determines whether the active date, which is a date of constraint, has passed. For example, if the active date is in the past (e.g., yesterday), then there is no longer a constraint on the task item (i.e., the item can be acted upon by a user). In another example, if the active date is today, then the user can start acting on the task item (e.g., the bicycle parts arrive today for the “Fix Bicycle” task). If the assigned active date is either prior to the current date (i.e., has passed) or is the current date, then the system 200 moves to step 330 to categorize the task item as an active item. If the assigned active date is neither prior to nor the current date, then the system 200 moves to step 332 to categorize the task item as an inactive item.

The active date can be visually expressed as follows:

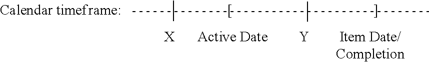

In the visually expressed calendar timeframe above, if the current date is at point “X,” then the planning item is within the range of inactiveness and can be categorized as inactive(i.e., step 332). The item remains inactive (i.e., not actionable) until the “Active Date.” If the current date is at point “Y,” then the planning item is within the range of activeness and can be categorized as active (i.e., step 330). The task item remains active until the date of completion (i.e., the status of the item becomes “complete”) and/or the item date. In some embodiments, the system 200 can reschedule the item date of a task that is “overdue” (i.e., the task is not completed by the item date originally assigned or defined by the contingency parameters (e.g., item date parameter provided by a user). In such embodiments, the system 200 automatically increments, or “rolls over,” the item date at the end of each day, and the task item becomes scheduled for the next day (i.e., with a new item date).

At decision step 324, if the system 200 determines the item being evaluated in the process 300B is not a task type, then the system 200 moves to decision step, or block, 334. At decision step 334, the system 200 determines whether the item is of an appointment type. If the planning item is an appointment item, then the system 200 proceeds to decision step, or block, 336 to determine whether the item date of the appointment item is the current date. If the item date is the current date, the system 200 proceeds to step 330 to categorize the appointment item as an active item. If the item date is not the current date, the system 200 proceeds to step 332 to categorize the appointment item as an inactive item. The system 200 follows the logic that a user needs to be notified of an appointment only at the date at which the appointment occurs. Having a constant (e.g., visual) reminder of the appointment, e.g., a week before the actual appointment may create unnecessary clutter and detracts from other important planning items requiring the user's attention.

If the planning item is not an appointment item, the system 200 moves to decision step, or block, 338. At decision step 338, the system 200 determines whether the item is of a calendar note type. If the item is not a calendar note, the process 300B ends. In some embodiments, if the item is a calendar note type, the system 200 proceeds to determine whether the item date of the calendar note item is the current date. If the item date is the current date, the system 200 proceeds to step 330 to categorize the calendar note item as an active item. If the item date is not the current date, the system 200 proceeds to step 332 to categorize the calendar note item as an inactive item.

In some embodiments, the system 200 does not perform step 336 for items of the calendar note type. In such embodiments, upon identifying an item as a calendar note type at decision step 338, the system 200 proceeds to step 332 to categorize the item as an inactive item. In such embodiments, the system 200 follows the logic that a user does not need to be notified of a calendar note (e.g., a birthday), as such item is not actionable and/or require to be acted upon by the user. Accordingly, a calendar note is categorized automatically as an inactive item, according to such embodiments, and is only displayed to the user, for example, in the PLAN view pane 402 of FIG. 1.

In some embodiments, the logic associated with the active date can be embodied as a policy that can be adjusted or configured by an administrator of the system 200. In some embodiments, an item of an appointment type can be assigned an active date. In such embodiments, the system 200 would analyze the active date of the appointment type similar to an item of a task type by executing steps 326 and 328. For example, a policy for the active date of an “appointment” planning item can be configured to cause the system 200 to automatically assign, to the appointment item, an active date that is within two days of the item date of the appointment item (i.e., any date within a two-day range extending from a current date to the appointment date). In such example, an appointment item would be categorized as an active item starting from the active date until the appointment date (i.e., item date), and would be categorized as an inactive item until the active date arrives. In another example, the active date for the appointment item can be configured to be any date within a week of the item date. The various policies regarding active date can be stored, for example, in the repository 205. The system 200 can access the policy to execute step(s) 326, 328, and/or 330 and 332.

FIG. 3C illustrates the process 300C that includes details of step 308 of the process 300A. In identifying the subset of one or more items to display to the user, the system 200 starts at step 340 to determine the particular view pane that has been selected (e.g., view pane 402, 440, or 450 of FIGS. 4A-4C). In some embodiments, the process 300C can be executed by the user selection receiver 250, the display output generator 260, and the calendar management engine 230 of FIG. 2 working in coordination. In some embodiments, the process 300C can be executed by other components of the system 200 of FIG. 2. For the sake of simplicity, the following discussion refers to the system 200 executing the process 300C. However, such reference is non-limiting and is done for the purposes of facilitating ease of understanding.

At step 342, the system 200 determines whether the ACT view pane 440 has been selected. If the selected pane is view pane 440, the system proceeds at step 344 to identify any planning items that are categorized as active items at step 304 of the process 300A. At step 346, the system 200 selects the active items to display them in the selected ACT view pane 440 for the user. Step 346 can be executed, for example, by the calendar management engine 230 sending the subset of one or more planning items to the display output generator 260 to populate a view pane of a graphical user interface with those items.

The display output generator 260 can be configured to generate at least a portion of the calendar information associated with the selected planning items. For example, the display output generator 260 generates item names for the selected planning items as a listing of items for display to the user, where the listing resembles a checklist of action items that a user can “check-off” to indicate completion of any of the items. In some embodiments, the display output generator 260 generates the listing in a chronological order based on the item dates. An example of such chronological listing is illustrated in FIG. 4B.

Referring back to the process 300C, if the view pane selected is not the ACT view pane 440, the system 200 proceeds to step 348 to determine whether the selected view pane is the PLAN view pane 402. The system 200 proceeds to step 350 to select all planning items to display for the user if the selected view pane is the view pane 402. Step 350 can be executed, for example, by the calendar management engine 230 sending the subset of planning items that includes, in this instance, all planning items to the display output generator 260 to populate a view pane of a graphical user interface with those items. The display output generator 260 can be configured to generate at least a portion (or all) of the calendar information associated with the selected planning items. For example, the display output generator 260 generates item names for the planning items to display in a chronological listing based on the item date of the planning items, as illustrated in FIG. 4A.

If the view pane selected is not the PLAN view pane 402, the system 200 proceeds to step 352 to determine whether the selected view pane is the DONE view pane 450. If the selected view pane is the view pane 450, the system 200 proceeds to step 354 to identify any planning items that are marked, at step 304 of the process 300A, as completed items and/or as inactive completed items (i.e., subcategory of inactive item). At step 356, the system 200 selects the completed items to display them in the selected view pane for the user. Step 356 can be executed, for example, by the calendar management engine 230 sending the subset of items to the display output generator 260 to populate a view pane of a graphical user interface with those items.

The display output generator 260 can be configured to generate at least a portion of the calendar information associated with the selected planning items. For example, the display output generator 260 generates item names for the selected planning items as a listing for display to the user, where the listing resembles a list of crossed-out planning items representative of the user's “check-off” submission to indicate completion. In some embodiments, the list of completed items include items that are no longer “active,” but not necessarily have been completed. For example, an appointment item becomes inactive when the appointment time and/or date has passed. Such past item no longer requires the user's attention (i.e., does not and cannot continue to be active), and as such, falls under the category of a completed item. In some embodiments, the display output generator 260 generates the listing in a chronological order based on the date of completion. An example of such chronological listing is illustrated in FIG. 4C.

Regarding the processes 300A, 300B, 300C, while the various steps, blocks or sub-processes can be presented in a given order, alternative embodiments can perform routines having steps, or employ systems having steps, blocks or sub-processes, in a different order, and some steps, sub-processes or blocks can be deleted, moved, added, subdivided, combined, and/or modified to provide alternative or sub-combinations. Each of these steps, blocks or sub-processes can be implemented in a variety of different ways. Also, while steps, sub-processes or blocks are at times shown as being performed in series, some steps, sub-processes or blocks can instead be performed in parallel, or can be performed at different times as will be recognized by a person of ordinary skill in the art. Further any specific numbers noted herein are only examples: alternative implementations can employ differing values or ranges.

FIGS. 4A-4C illustrate example graphical user interfaces (GUIs) 400A, 400B, 400C of the Calendar App, as presented on a display 430 of a user device (e.g., user device 102 of FIG. 1). A particular GUI, of the GUIs 400A-400C, is selectively presented on the display 430 based on a view pane selection 408 selected by the user. Accordingly, depending on the GUI selected, a portion of calendar information associated with one or more listings, or subsets, of planning items is presented on the display 430 for the user. In particular, the subset of planning items, and associated calendar information, are retrieved from a storage (e.g., repository 205 of FIG. 2) of a system executing the Calendar App (e.g., system 200 of FIG. 2) for display in the selected view pane (e.g., GUI 400A, 400B, or 400C). The planning items displayed can include tasks, appointments, and/or calendar notes. A planning item can be stored in a storage (e.g., repository 205) by the storing of the contingency parameters associated with the item (e.g., the item name, the item date, etc.).

Note that in the embodiments illustrated in FIGS. 4A-4C, three different view panes are illustrated to provide a way for the user to see specific modal views of the different listings or filtered subsets of those listings with a single touch (i.e., view pane selection 408) of a “three-way switch” that always exists on the display 430. However, in some embodiments, a different number of view panes can be illustrated on the display 430. For example, in some embodiments only two different view panes (e.g., PLAN view 402 and ACT view 440) are illustrated. In such embodiments, the PLAN view 402 can include all future planning items, in addition to all past, or completed, planning items. The past planning items (or completed/done items) can be displayed different from the future planning items, such as being visually “checked-off” or “crossed-out.”

In another example, in some embodiments, an additional view pane may be illustrated on the display 430, such as an EXPIRED view pane that includes items that have already been acted upon or expired. Additionally, in some embodiments each of the view panes may be further filtered. For example, in some embodiments, the ACT view pane 440 can include planning items that are further filtered according to criteria that are not related to timeliness (i.e., when an item becomes actionable (e.g., start date)). An example criteria can be, for example, location.

In some embodiments, the planning items are received directly from a user through submission of contingency parameters as inputs to the Calendar App when using the user device (e.g., mouse, keyboard, touchscreen, microphone, etc.). In some embodiments, a portion of the contingency parameters related to a particular planning item can be received from the Calendar App itself. In such embodiments, the Calendar App generates default values for certain contingency parameters that have not been received, or submitted, by the user. In some embodiments, the planning items are received indirectly from a user through a third-party application (e.g., Microsoft® Outlook®, iCloud®, etc.). In such embodiments, the user submits the planning items (e.g., parameters that define the items) to the third-party applications, which can transmit the data (e.g., sync data) to the Calendar App (e.g., via the network interface 220 of FIG. 2).

Referring to FIG. 4A, the user interface 400A includes a view pane 402 (“PLAN view pane 402”) that displays at least a portion of calendar information related to a subset of planning items submitted to the Calendar App, where the subset includes all of the planning items. A portion of calendar information can include, for example, an item date, an item name, or any item indicator (e.g., tag, priority marker, etc.). A user can select (e.g., mouse-click, touch, keyboard input, etc.) a view pane selection 408A on the GUI 400A to display the PLAN view pane 402. The PLAN view pane 402 provides a non-filtered, overview of planning items to assist the user in the personal planning of short and long-term goals. In particular, the PLAN view pane 402 displays both active items and inactive (i.e., non-actionable) items. In some embodiments, the PLAN view pane 402 can also display completed items (i.e., items having a status of complete). In such embodiments, the completed items can be visually crossed-out to differentiate them from other inactive items that are not yet completed.

The PLAN view pane 402 of the embodiment in FIG. 4A includes a simplified calendar 404 with a marker of “Today” to indicate today's date and a list of relevant dates (e.g., 410, 414, 418, 422, 424, 426) with respective pending planning items (e.g., 412, 416, 420, and 428). The list of relevant dates can be configured by a user or by a system admin to display a specified or predetermined number of dates. In one example, the list of relevant dates can be configured to display dates for remaining days of the week associated with a current date 410 (e.g., “June 26,” “June 27,” “June 28,” and “June 29”), regardless of whether there is a planning item scheduled for any of those remaining dates. In another example, the list of relevant dates can be configured to display only dates at which planning items are scheduled.

In yet another example, the list of relevant dates can be configured to display the remaining dates of the week and any subsequently chronological dates with planning items scheduled; this example is shown in FIG. 4A. Each of the planning items in the list of relevant dates is chronologically displayed based on the date the item is scheduled. The term “scheduled” as used here refers to the item date of a planning item. Under the current date 410 (i.e., “June 26”), planning items 412A-C that are scheduled for the current date 410 are displayed. Each of the planning items 412A-C has an item date of June 26. The next relevant date that is not part of the remaining week associated with the current date 410 is a next relevant date 414. The PLAN view pane 402 includes the relevant 414 because it is the first chronological date that has a planning item 416 scheduled. In some embodiments, a planning item can be repeated for several days, e.g., a calendar note signifying an event. For example, a planning item 420A-C takes place over a weekend from date 418, to date 422, to date 424, and as such, the planning item is repeated for the dates 418, 422, and 424.

In some embodiments, the GUI 402 can display one or more planning items 428 that are not scheduled for a specific date, but is scheduled at some point in time (e.g., “SOMEDAY”). That is, a planning item can have a flexible item date that is in the indefinite future.

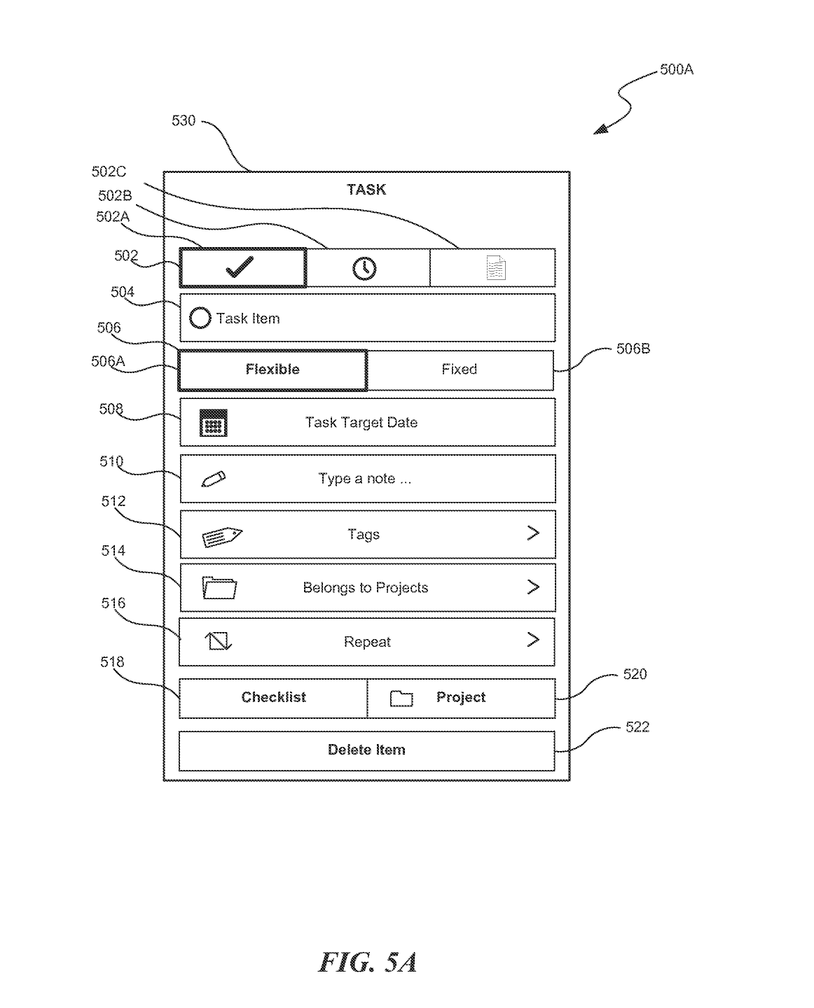

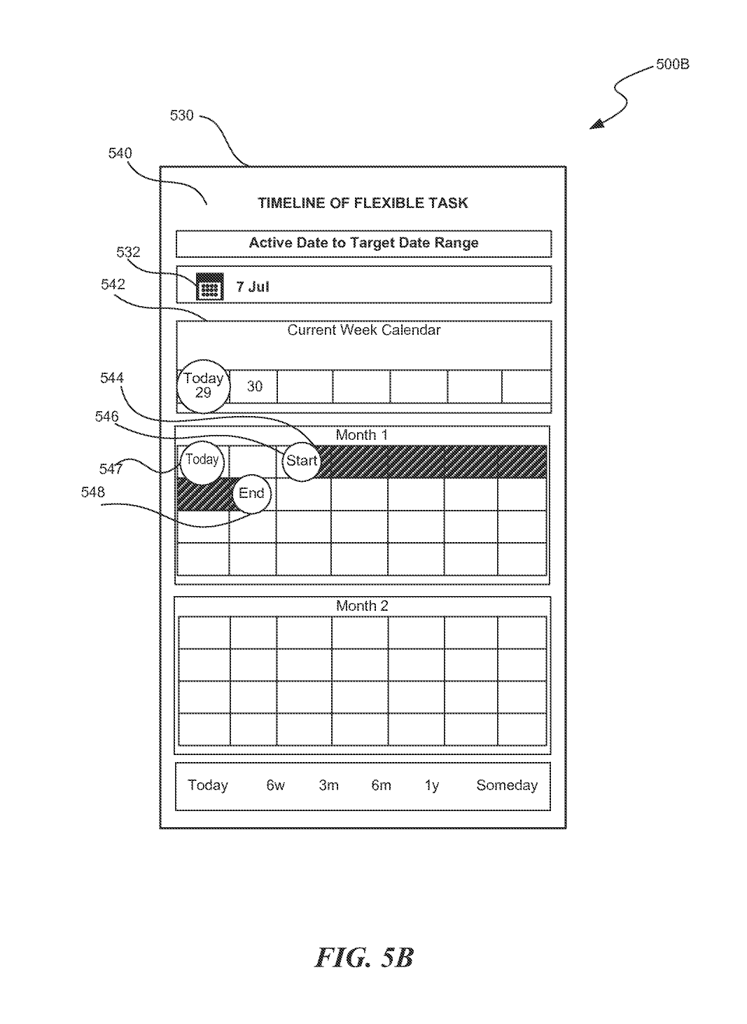

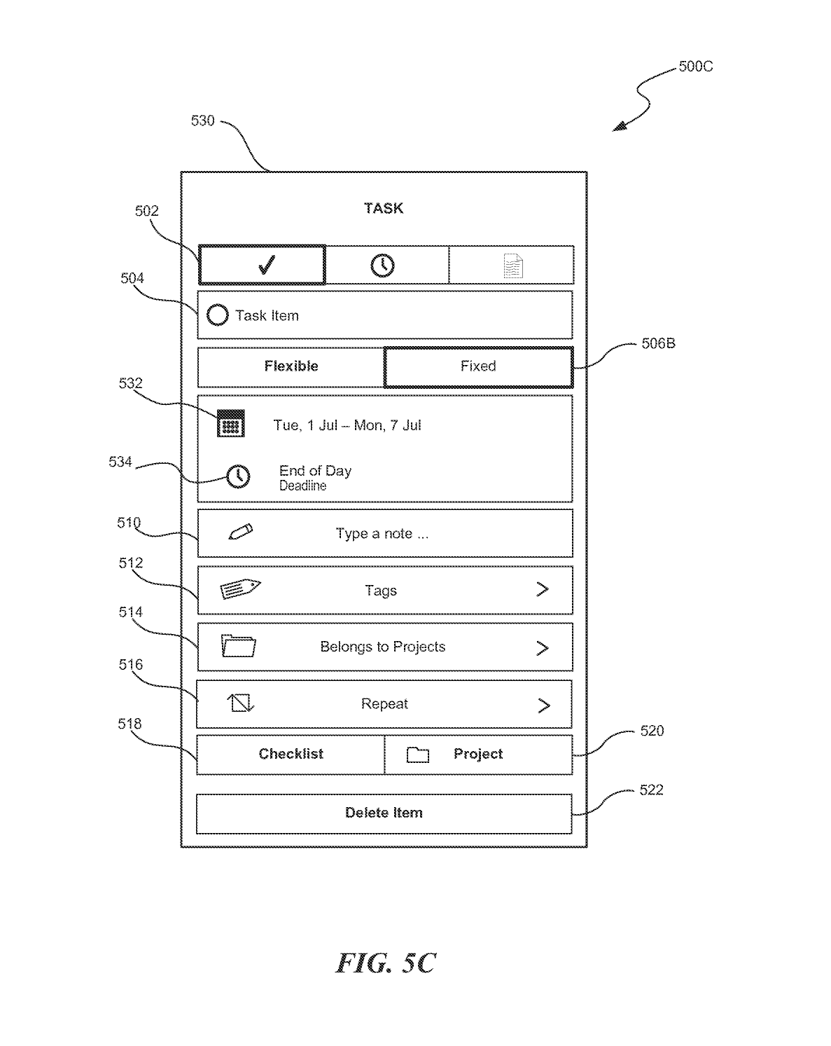

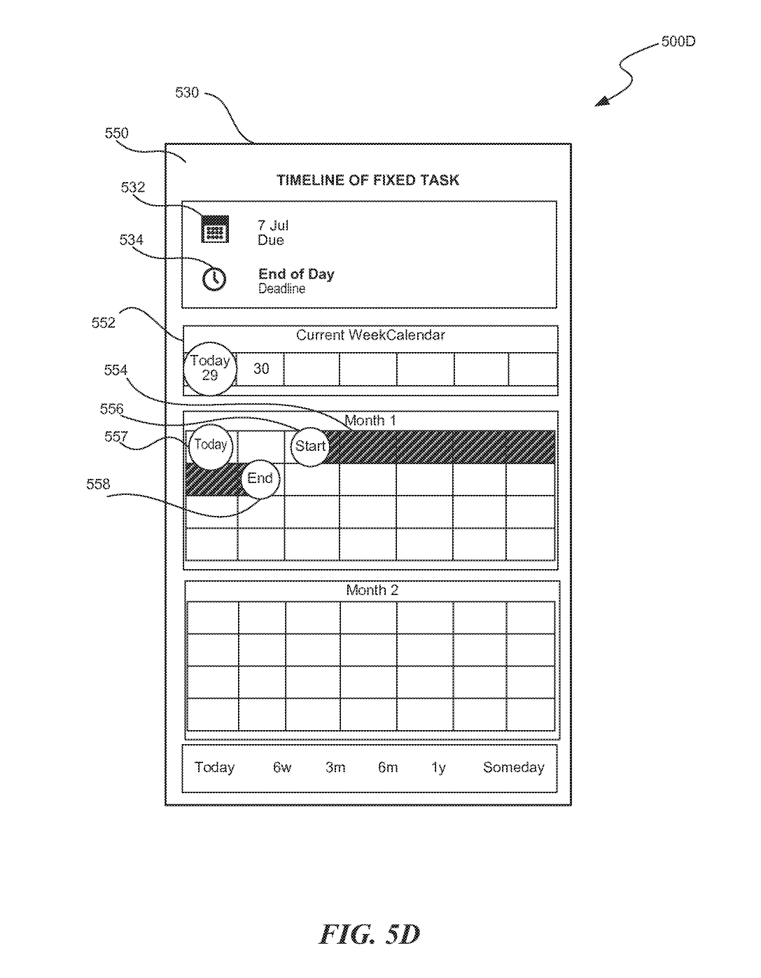

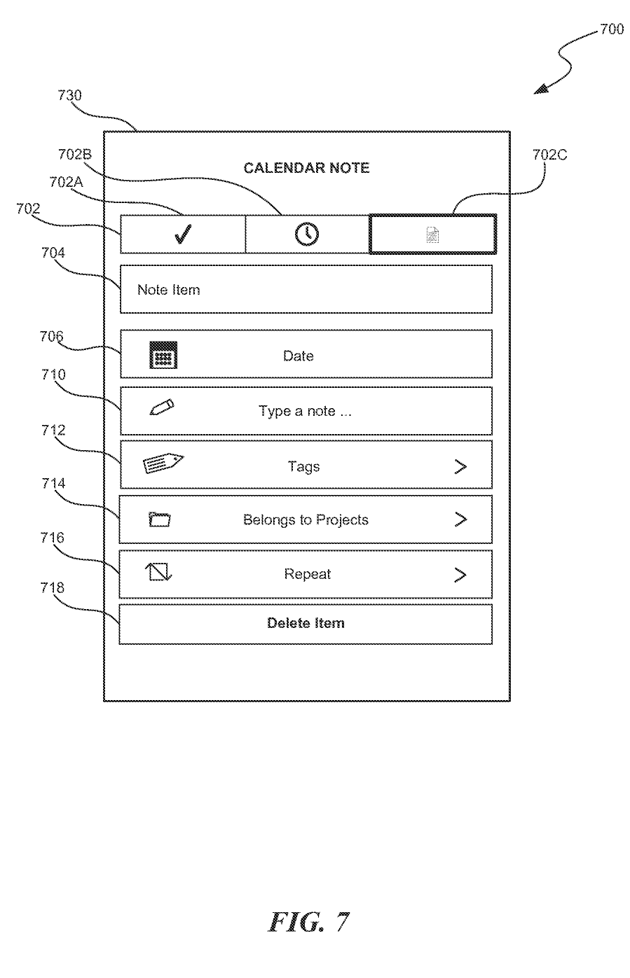

In some embodiments, the GUI 400A includes an insertion point marker 406B that can be used in conjunction with an insertion option 406A within the view pane 402 to allow a user to add one or more additional planning items (e.g., by submitting one or more contingency parameters related to a planning item). A user can place the insertion point marker 406B at a particular position between any two dates, or any two existing planning items associated with the dates, to indicate a particular date at which to insert, or add, a particular planning item to the Calendar App. The user can next select the insertion option 406A to add a planning item at the particular position of the insertion point marker 406B. In response to the selection of the insertion option 406A, a new GUI (e.g., GUI 500A of FIG. 5A, GUI 600 of FIG. 5, or GUI 700 of FIG. 7) can be generated to enable the user to submit one or more contingency parameters defining the particular planning item. The “item date” contingency parameter of the particular planning item can be set, for example, as the date associated with the particular position at which the insertion point marker 406B is placed.

In some embodiments, the insertion point marker 406B can enable the user to control the display of the planning items. For example, the user can utilize the insertion point marker 406B (e.g., by moving it up or down) to scroll through the calendar dates to view the planning items associated with the dates. In such example, the user can stop at a particular position to indicate a desired calendar date to add a new planning item (i.e., by selecting the insertion option 406A as discussed above). In another example, planning items displayed above the insertion point marker 406B can be fixed while planning items displayed below the marker 406B may be scrolled through as a list.

FIG. 4B illustrates the GUI 400B that can be presented on a display of a user device. The GUI 400B includes a view pane 440 (“ACT view pane 440”) for displaying at least a portion of calendar information related to a subset of planning items submitted to the Calendar App. A user can select (e.g., mouse-click, touch, keyboard input, etc.) a view pane selection 408B on the GUI 400B to display the ACT view pane 440. The ACT view pane 440 provides a filtered view of the planning items to assist the user in focusing on certain items that are “actionable” without the distraction of other items. In particular, the ACT view pane 440 displays only active items to highly those particular items (over other items that the user cannot act upon or perform). Whether a planning item is an active item (i.e., a planning item with an “active” status) depends on the item type, as discussed above with respect to FIG. 3B.

According to one embodiment, the ACT view pane 440 includes a first list of active items (e.g., active items 444A-C) and a second list of active items (e.g., active items 448A-C). The first list of active items is associated with a current date 442 (i.e., “TODAY”) and the second list of active items is associated with a future date 446 (i.e., “AHEAD”). In some embodiments, the active items are displayed in the first and second lists in a chronological order based on the item date (i.e., respective item dates of the items).

The active items selected for display within each list (e.g., first list or second list) can be configured or specified by a user or by a system admin. In some embodiments, the active items are selected for display based on a specified number of the active items. In such embodiments, a system admin can specify, for example, that only the first 15 active items are displayed within the first listing associated with the current date 442, and the remaining active items can be viewed by scrolling down the first listing.

In some embodiments, an active item is selected for display within a particular list based on a project assignment associated with the item. In such embodiments, a “task” type item that has been redefined as a project with a (new) item date associated with the project may be displayed within the second list, as opposed to the first list. The project item date governs whether the task item is an active item, where the (old) item date associated with the task item has been updated to a (new) item date associated with the project item. For example, a task item “Fix Bicycle,” which has an item date of the current date 442, is redefined as a project with an item date of two months from the current date 442. In this example, the “Fix Bicycle” project item will then selected by the system for display within the second list. On the other hand, in the same example, another task item “Buy Gears” with an item date of the current date 442 will be selected for display within the first list.

Referring back to embodiment of the ACT view pane 440 of FIG. 4B, the ACT view pane 440 includes the first list associated with the current date 442 and the second list associated with the future date 446. Planning items 1-n (where n is an integer) 444A-444C displayed within the first list can be items that require the user's immediate attention (i.e., “actionable”). These items 444A-444C can be planning items, for example, that are of the task type and do not have an active date, or of the task type and have an active date that has already passed (i.e., the current date is between the active date and the item date/completion date. Planning items 1-n (where n is an integer) 448A-448C displayed within the second list associated with the future date 446 can be items that require the user's attention (i.e., actionable), but have item dates that are in the future. Other embodiments as discussed above can be applied in the selection of planning items to be displayed within the first and second lists respectively.

In some embodiments, the ACT view pane 440 enables the user to mark any item included in the first list and the second list, respectively, as “Completed” by interacting with the item, e.g., select a circle next to the item. In such embodiments, the items that have the status of complete are displayed in the DONE view pane 450 of FIG. 4C.

FIG. 4C illustrates the GUI 400C presented on the display 430. The GUI 400C includes a view pane 450 (“DONE view pane 450”) to display at least a portion of calendar information (e.g., item name and completion date) related to a subset of all planning items submitted to the Calendar App. A user can select (e.g., mouse-click, touch, keyboard input, etc.) a view pane selection 408C on the GUI 400C to display the DONE view pane 450.

The DONE view pane 450 provides a filtered view of the planning items to assist the user in viewing only certain items without the distraction of other items. In particular, the DONE view pane 450 displays only completed items. Such completed items include any planning item(s) that have been marked as “completed” item(s). A planning item can be marked as completed by a user, e.g., selecting a circle next to an item to indicate completion or updating a contingency parameter. Alternatively, a planning item can be marked as completed by the Calendar App upon a time passing of the occurrence of the item. For example, an appointment set for June 30 at 9 AM can be automatically marked as completed at a date and/or time subsequent to the appointment's item date/time (e.g., June 30 at 9:01 AM, July 1 at 9 AM, etc.).

According to one embodiment, the DONE view pane 450 includes the completed items organized in a chronological order based on the date at which each item has been completed. The DONE view pane 450 displays, for example, a first past date 452 of “June 16” and accompanying completed items 1-n (where n is an integer) (i.e., items 454A-454C). Chronologically subsequent to the first past date 452 is a second past date 456 of “June 17” that is accompanied by completed item 458. In the embodiment illustrated in FIG. 4C, no other items have been completed between the second past date 456 until a third past date 460. As such, the third past date 460 of “June 22” is subsequently displayed with a completed item 464, and the other past dates, e.g., “June 18-June 21,” are not displayed within the DONE view pane 450. A current date 468 of “TODAY” is displayed with accompanied completed item 470 to indicate the item has been completed today.

FIGS. 5A-5D illustrate example graphical user interfaces (GUIs) 500A, 500B, 500C associated with a task item of the Calendar App. The GUIs 500A, 500B, 500C can be presented on a display 530 of a user device (e.g., user device 102 of FIG. 1). In accordance with an embodiment, a user can interact with the features of the GUIs 500A, 500B, 500C to submit, or input, one or more contingency parameters in creating a task item using the Calendar App.

Referring to FIG. 5A, the GUI 500A includes an item type field 502 that allows the user to select, or input, a parameter value for the “item type” contingency parameter. The parameter value can be any of a task type 502A, an appointment type 502B, or a calendar note type 502C. In the embodiment of the GUI 500A, the task type 502A is selected to create a task planning item, or task. The user can submit, or input, a name for the “item name” contingency parameter in an item name field 504. An example item name is “Fix Bicycle.”

In some embodiments, the GUI 500A includes a subtype field 506 that allows a user to submit, or input, a parameter value for a “subtype” contingency parameter associated with the task type parameter. The subtype parameter value can be a flexible type 506A or a fixed type 506B. The subtype parameter value specifies whether the task item to be created is a “fixed” task or a “flexible” task. As used here, a “fixed” task refers to a task with a fixed item date and/or fixed target time; the task is due, i.e., must be completed or desired to be completed, by a specific date that cannot be adjusted or moved. For example, a user would create a fixed task the user must act on the task at the item date or else, e.g., undesirable consequences will ensue. Example conventional names for the fixed task can include “hard-deadline task,” “deadline task,” “hard task” or “promise.”

As used here, a “flexible” task refers to a task with a relatively flexible, or moving, item date; the task does not have to be completed by a specific date, but rather has a due date that would not yield undesirable consequences (i.e., the item date of the flexible task can be adjusted or moved). Example convention names for the fixed task can include “soft-deadline task,” “soft task,” “to-do item,” “simple task,” or “ideal goal.”

In some embodiments, the GUI 500A includes a task item date field 508 that allows the user to submit, or input, an item date parameter value for the task item. The date value can be adjusted at any time (e.g., first time creating the task item or a subsequent time updating the task item).

In some embodiments, selection of the task target date field 508 causes the GUI 500B of FIG. 500B to be generated in response. The GUI 500B includes a timeline pane 540 that is associated with the flexible task. The timeline pane 540 is generated in the GUI 500B to display the range of dates during which the task item is active (i.e., an active item with a status of active). In particular, the timeline pane 540 includes a current week calendar 542 and a timeline 544 corresponding to the current week calendar 542.

In some embodiments, a user can adjust a start date 546 and an end date 548 of the task item by interacting with the timeline 544 included in the timeline pane 540. Example interactions include touch-and-drag the start date 544, double-click a particular date displayed to indicate selection of a new start date, etc.

The start date 546 indicates which date the task item can be actionable, or acted upon, by the user. In some embodiments, the start date can be a current date (i.e., “TODAY”) where there is no constraint on the planning item (i.e., it can be completed right now, if so desired by the user). In some embodiments, the start date 546 can be the active date assigned to a planning item, as discussed above. In such embodiments, the task item remains an inactive item until the active date. The active date can be assigned by the user. For example, the active date is a date that the user assigns to a task item to indicate real-life circumstances that prevent the user from acting upon the task item. For example, the start date can indicate the date that bike parts arrive for the task “Fix Bicycle,” where nothing can be done until that date when the bike part arrives.

The end date 548 indicates which date the task item is desired to be performed, or completed, by the user. The end date 548 can be the item date 508 of GUI 500A in some embodiments. In some embodiments, where the task item is flexible, the end date 548 can update every day. For example, the end date 548 is first specified by the user to be June 30. When June 30 passes (e.g., on a current date of July 1) and the task item is still not completed, the end date 548 automatically updates to, e.g., July 1.

In some embodiments, the GUI 500A also includes a detailed note option 510, a tag option 512, and a delete option 522. The detailed note option 510 enables the user to submit a detailed note about the particular task. The tag option 512 enables the user to mark the task item with a particular tag to organize one or more task items according to the particular tag (e.g., “work,” “home,” “errands,” “hobbies,” etc.) The delete option 522 enables the user to delete the task item.

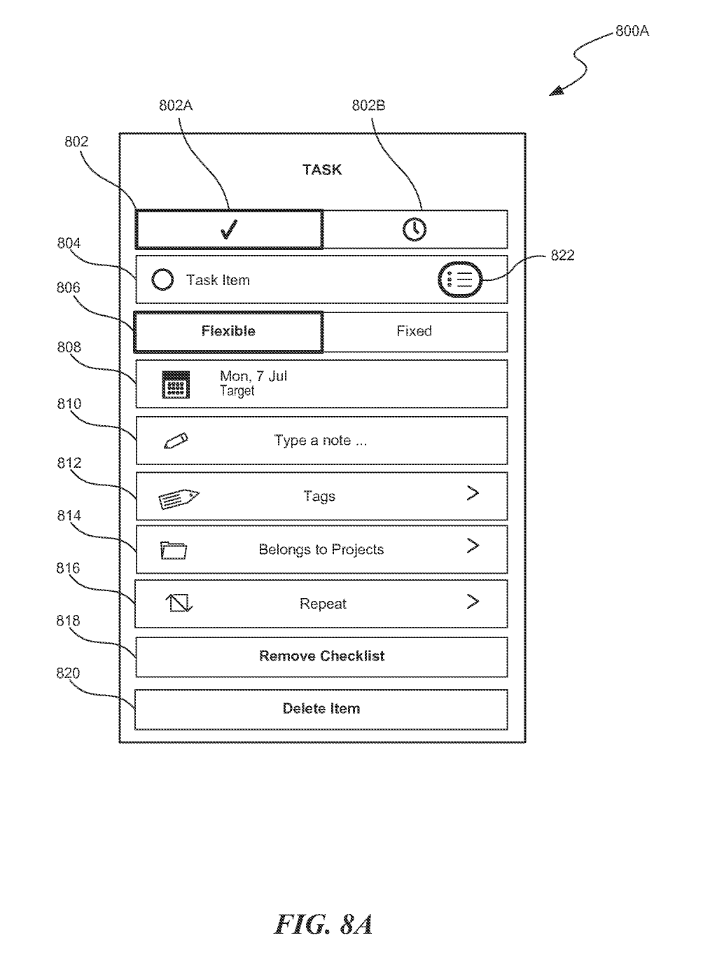

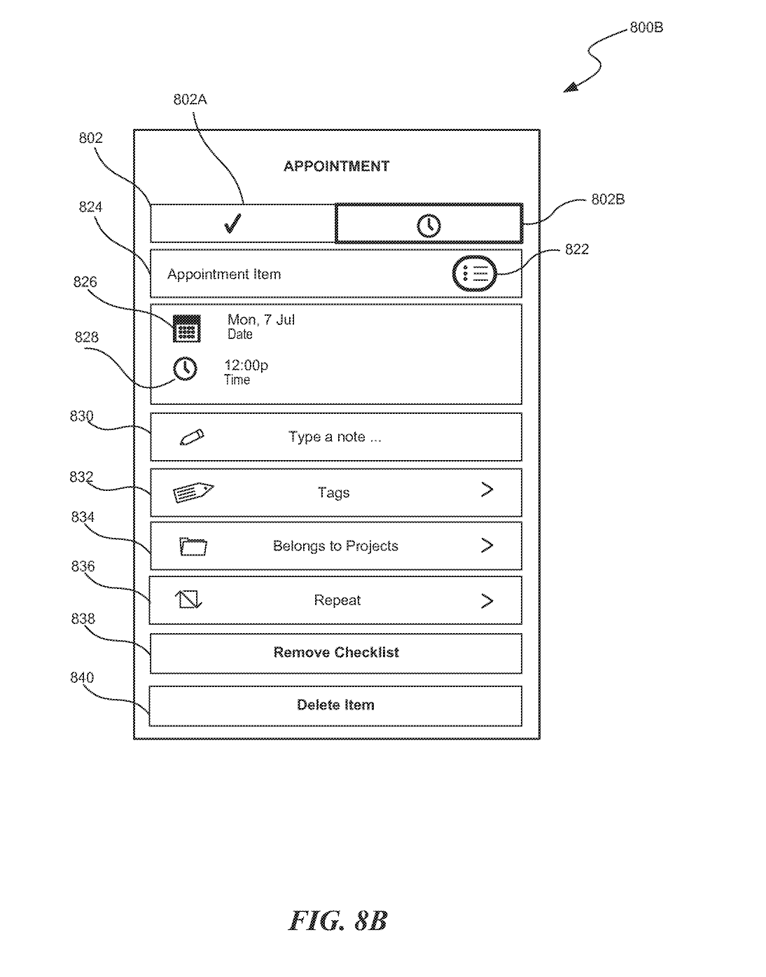

In some embodiments, the GUI 500A includes a project assignment option 514, a repeat option 516, a checklist creation option 518, and a project creation option 520. The repeat option 516 enables the user to specify for the task item to repeat. Details regarding the project assignment option 514, the checklist creation option 518, and the project creation option 520 will be discussed below with respect to FIGS. 8-10.

FIG. 5B illustrates an example graphical user interface (GUI) 500B that includes a timeline view pane 540 (or “timeline pane 540”) associated with a flexible task item. In some embodiments, the timeline pane 540 includes an item date field 532 to indicate the item date at which the task must be completed, or desired to be completed. In some embodiments, the timeline pane 540 includes a visual representation, or display, of a calendar for the current week (i.e., “Current Week Calendar 542”). In some embodiments, the timeline pane 540 includes a visual representation, or display, of a timeline 544 that extends from a current date 547 (i.e., “Today”) to an end date 548, or item date, of the flexible task item. In some embodiments, the user is able to adjust the timeline 544 by submitting, or inputting, an active date contingency parameter that sets a constraint on the flexible task item. The value of the active date contingency parameter indicates an active date 546 at which the flexible task item becomes “actionable” (i.e., can be categorized as an active item).

In some embodiments, in response to receiving the active date contingency parameter from the user (e.g., by receiving a touch screen input on a portion of the timeline 544 that is indicative of a date), the timeline 544 is automatically updated (e.g., by the system 200 of FIG. 2) to extend (e.g., visually) from the active date 546 to the end date 548.

In some embodiments, in response to receiving the active date contingency parameter, the ACT view pane (e.g., view pane 400B of FIG. 4B) is automatically updated based on the active date 546 (i.e., value of the active date contingency parameter), as the flexible task item may have to be re-categorized (e.g., to an inactive item). In such embodiments, the ACT view pane really is a timeliness control that has everything to do with timelines.

In some embodiments, an appointment item can also have a timeline similar to the timeline 544 of the fixed task item or flexible task item. In such embodiments, the appointment item has an implied timeline (i.e., appointments have an implied one-day timeline on the day of the appointment).

FIG. 5C illustrates the GUI 500C for submitting contingency parameters to create a fixed task. The GUI 500C includes the fields and/or options 502, 504, 506, 510, 512, 514, 516, 518, 520, 522 of the GUI 500A. The GUI 500C further includes an item date field 532 and a target time field 534. The item date field 532 enables the user to select the item date (i.e., parameter value for the “item date” contingency parameter) at which the item must be completed. The target time field 534 enables the user to select the target time (i.e., parameter value for the “target time” contingency parameter). Inclusion of the target time field 534 enables the user to specify a specific time when the task must be completed, in addition to the specific date for the completion.

In some embodiments, similar to the flexible task illustrated in GUI 500B of FIG. 5B, a fixed task can also have a timeline that visually enables the user to specify the start (i.e., active date) and end date of the fixed task. An example timeline is illustrated in the GUI 500D of FIG. 5D. The GUI 500 D includes a timeline pane 550 associated with the fixed task. The timeline pane 550 differs from the timeline view pane 540 by having the target time field 534.

FIG. 5D illustrates an example graphical user interface (GUI) 500D that includes a timeline view pane 550 (or “timeline pane 550”) associated with a fixed task item. In some embodiments, the timeline pane 550 includes an item date field 532 to indicate the item date at which the task must be completed, or desired to be completed. The timeline pane 550 also includes a target time field 534 to indicate the specific time that the task must be completed, or desired to be completed.

In some embodiments, the timeline pane 550 includes a visual representation, or display, of a calendar for the current week (i.e., “Current Week Calendar 552”). In some embodiments, the timeline pane 550 includes a visual representation, or display, of a timeline 554 that extends from a current date (i.e., “Today”) to an end date 558, or item date, of the fixed task item. In some embodiments, the user is able to adjust the timeline 554 by submitting, or inputting, an active date contingency parameter that sets a constraint on the fixed task item. The value of the active date contingency parameter indicates an active date 556 at which the fixed task item becomes “actionable” (i.e., can be categorized as an active item).

In some embodiments, in response to receiving the active date contingency parameter from the user (e.g., by receiving a touch screen input on a portion of the timeline 554 that is indicative of a date), the timeline 554 is automatically updated (e.g., by the system 200 of FIG. 2) to extend (visually) from the active date 556 to the end date 558. In some embodiments, in response to receiving the active date contingency parameter, the ACT view pane (e.g., view pane 400B of FIG. 4B) is automatically updated based on the active date 556 (i.e., value of the active date contingency parameter), as the fixed task item may have to be re-categorized (e.g., to an inactive item).

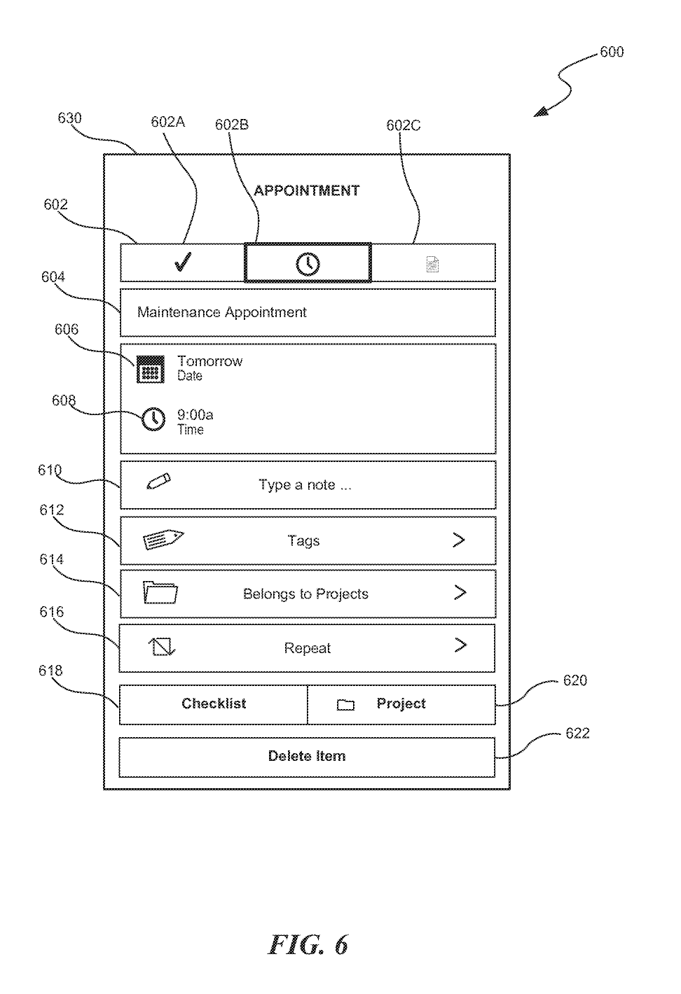

FIG. 6 illustrates an example graphical user interface (GUI) 600 associated with an appointment item of the Calendar App. The GUI 600 is presented on a display 630 of a user device (e.g., user device 102 of FIG. 1). In accordance with an embodiment, a user can interact with the features of the GUI 600 to submit one or more contingency parameters in creating an appointment item using the Calendar App. The GUI 600 includes an item type field 602 that allows the user to select a parameter value for the “item type” contingency parameter. The parameter value can be any of a task type 602A, an appointment type 602B, or a calendar note type 602C. In the embodiment of FIG. 6, the appointment type 602B is selected by the user to create an appointment planning item, or appointment.

The GUI 600 also includes an item name field 604 (similar to the item name field 504 of FIG. 5A), an appointment item date field 606, an appointment target time field 608, a detailed note option 610 (similar to the detailed note option 510 of FIG. 5A), a tag option 612 (similar to the tag option 512 of FIG. 5A), and a delete option 622 (similar to the delete option 522 of FIG. 5A). In some embodiments, the GUI 600 includes a project assignment option 614 (similar to the project assignment option 514 of FIG. 5A), a repeat option 616 (similar to the repeat option 516 of FIG. 5A), a checklist creation option 618 (similar to the checklist creation option 518 of FIG. 5A), and a project creation option 620 (similar to the project creation option 520 of FIG. 5A). Details regarding the project assignment option 614, the checklist creation option 618, and the project creation option 620 will be discussed below with respect to FIGS. 8-10.

FIG. 7 illustrates an example graphical user interface (GUI) 700 associated with a calendar note item of the Calendar App. The GUI 700 is presented on a display 730 of a user device (e.g., user device 102 of FIG. 1). In accordance with an embodiment, a user can interact with the features of the GUI 700 to input, or submit, one or more contingency parameters in creating a calendar note item using the Calendar App. The GUI 700 includes an item type field 702 that allows the user to select a parameter value for the “item type” contingency parameter. The parameter value can be any of a task type 702A, an appointment type 702B, or a calendar note type 702C. In the embodiment of FIG. 7, the calendar note type 702C is selected by the user to create a calendar note planning item, or a calendar note.

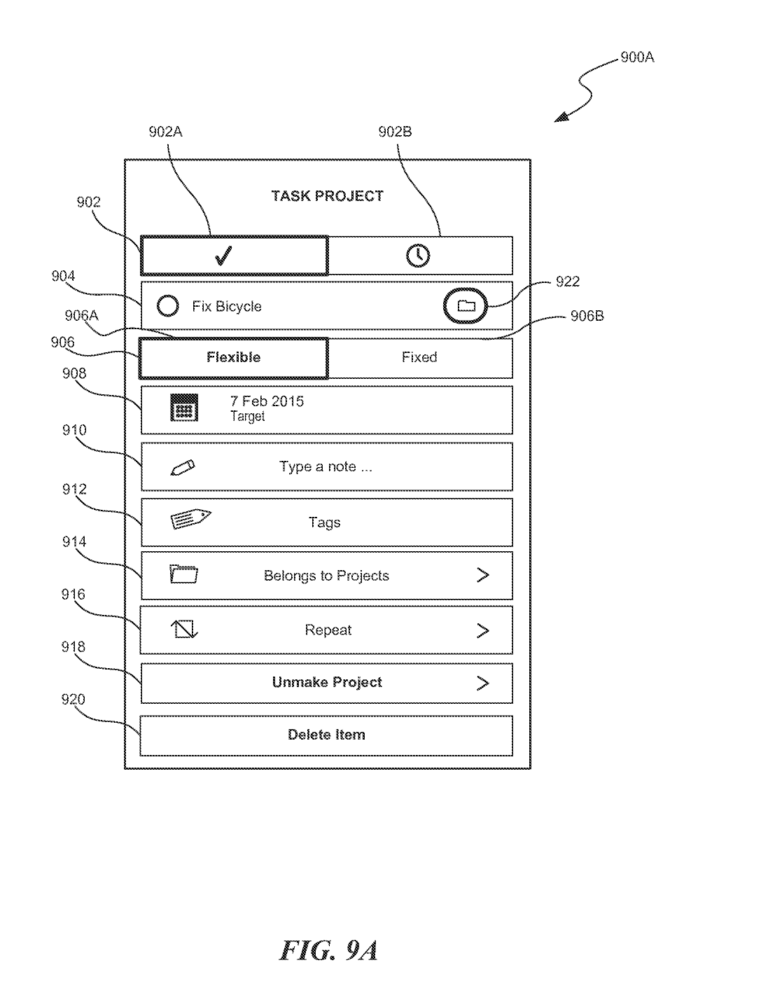

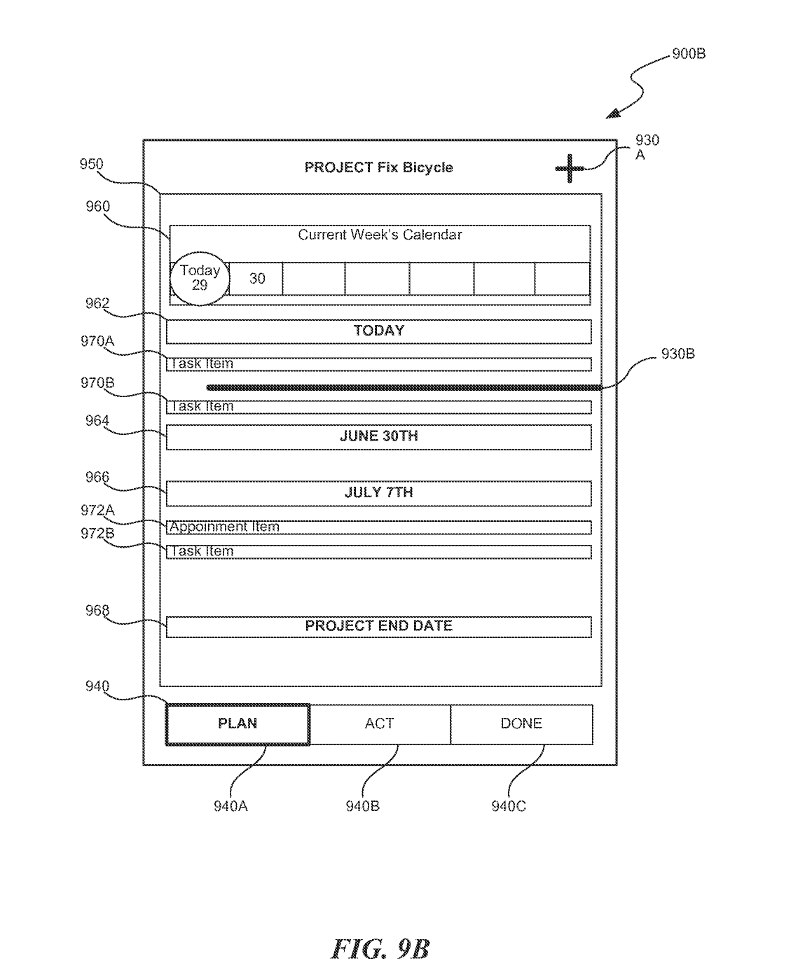

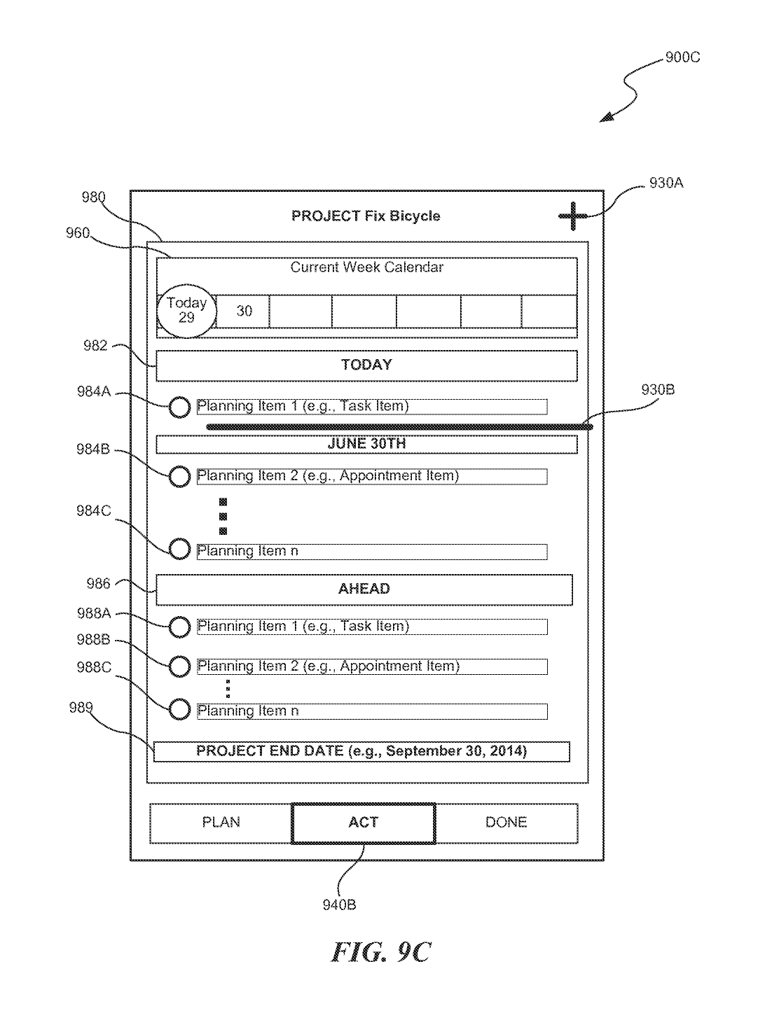

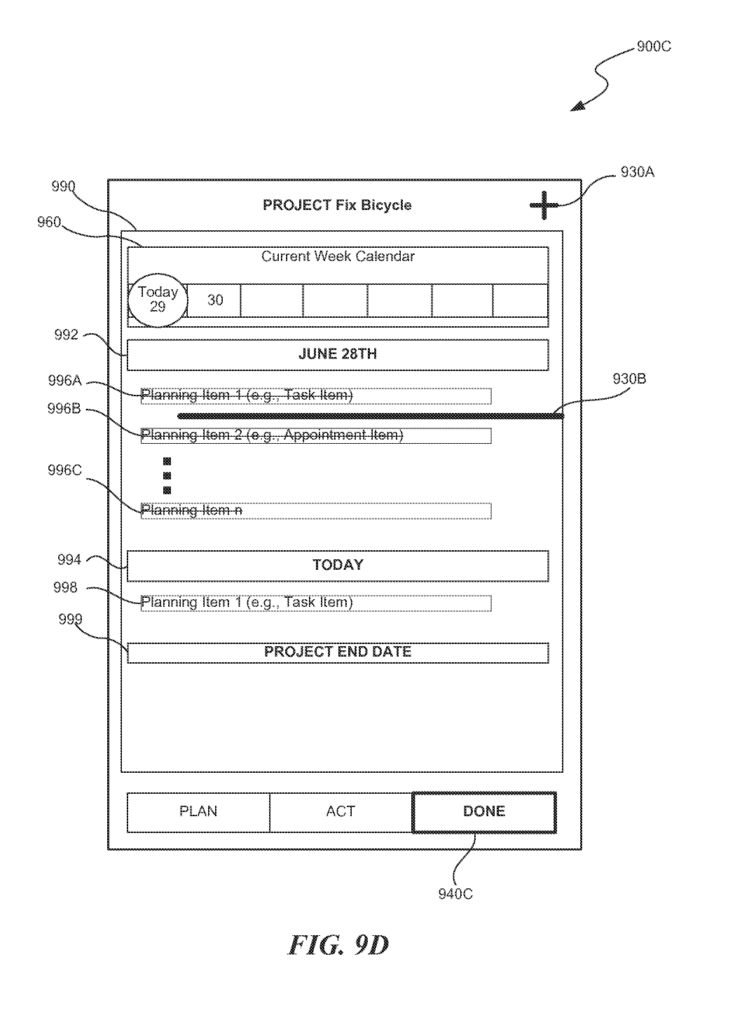

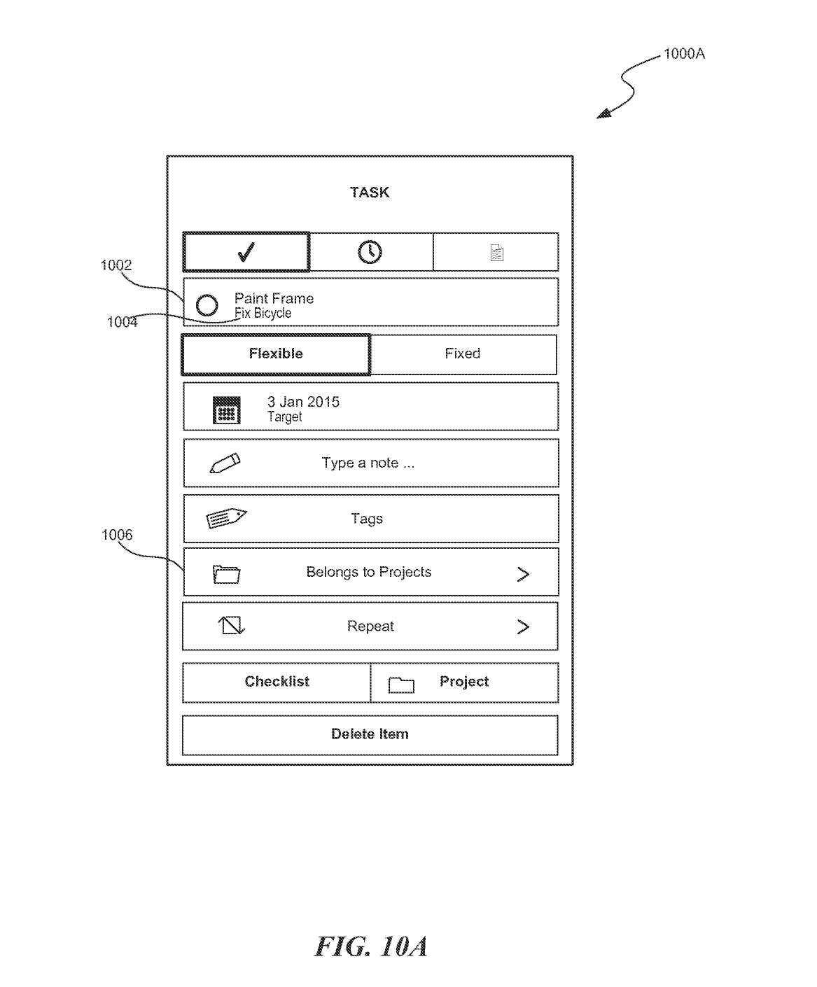

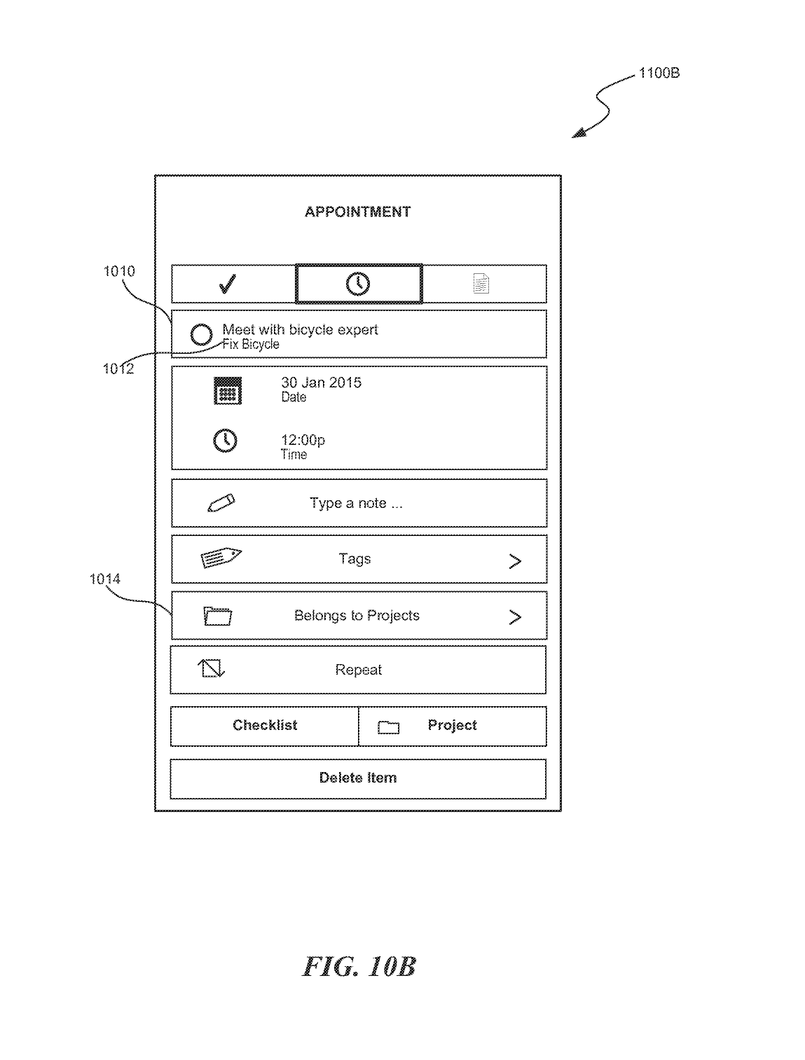

The GUI 700 also includes an item name field 704 (similar to the item name field 504 of FIG. 5A), a calendar note item date field 706, a detailed note option 710 (similar to the detailed note option 510 of FIG. 5A), a tag option 712 (similar to the tag option 512 of FIG. 5A), a delete option 718 (similar to the delete option 522 of FIG. 5A), and a repeat option 716 (similar to the repeat option 516 of FIG. 5A). In some embodiments, the GUI 700 includes a project assignment option 714 (similar to the project assignment option 514 of FIG. 5A). Details regarding the project assignment option 714 will be discussed below with respect to FIGS. 9-10.

FIGS. 8A-8B illustrates graphical user interfaces (GUIs) 800A, 800B for creating a checklist associated with a task item and an appointment item, respectively. The GUIs 800A, 800B can be presented on a display of a user device (e.g., user device 102 of FIG. 1). In accordance with an embodiment, a user can interact with various features of the GUIs 800A, 800B, respectively, to submit one or more contingency parameters in creating a checklist associated with either a task item or an appointment item.

FIG. 8A illustrates a GUI 800A that allows a user to create a checklist for a task item by interacting with the GUI 800A (e.g., using a mouse, touchscreen, keyboard, microphone, etc.). According to one embodiment, the GUI 800A is generated in response to the user selecting a checklist creation option included in a GUI for creating and/or editing a particular task item (e.g., the checklist creation option 518 of FIGS. 5A and 5C). In such embodiment, in response to the user selecting the checklist creation option, the generated GUI 800A is generated to include a checklist indicator 822 to indicate the existence of a checklist for the task item. Upon creation of the checklist, the existence of the checklist becomes a contingency parameter (e.g., checklist indicator parameter) that defines an aspect of the task item. The checklist indicator 822 enables the user, upon selecting the indicator 822, to add a set of one or more sub-items (e.g., sub-tasks) for the particular task item (e.g., by inputting the sub-items), where the set of sub-items operates as the checklist associated with the particular task item. An example of the particular task item is “Fix Bicycle” and example sub-task items can include “Buy new tires” and “Buy air pump.” Accordingly, according to the embodiment of FIG. 8A, a user can add a checklist to any task item, and can open the checklist directly from the task item (e.g., via the checklist indicator 822). Upon the user clicking on the checklist indicator 822, the set of one or more sub-items associated with the task item are displayed.

In some embodiments, the generated GUI 800A includes a remove checklist option 818. The remove checklist option 818 enables the user to remove, or delete, the checklist (e.g., the checklist that has been created by selecting the checklist creation option 518 of FIG. 5A).

In some embodiments, the generated GUI 800A also includes an item type field 802 (similar to the item name field 504 of FIG. 5A), an item name field 804 (similar to the item name field 504 of FIG. 5), a subtype field 806 (similar to the subtype field 506 of FIG. 5A), a task item date field 808 (similar to the task item date field 508 of FIG. 5A), a detailed note option 810 (similar to the detailed note option 510 of FIG. 5A), a tag option 812 (similar to the tag option 512 of FIG. 5A), and a repeat option 816 (similar to the repeat option 516 of FIG. 5A). In some embodiments, the generated GUI 800A includes a project assignment option 814. In some embodiments, the generated GUI 800A includes a delete option 820 (similar to the delete option 522 of FIG. 5A). The delete option 820 enables the user to remove, or delete, the particular task item.

FIG. 8B illustrates a GUI 800B that allows a user to create a checklist for an appointment item by interacting with the GUI 800B (e.g., using a mouse, touchscreen, keyboard, microphone, etc.). According to one embodiment, the GUI 800B is generated in response to the user selecting a checklist creation option included in a GUI for creating and/or editing a particular appointment item (e.g., the checklist creation option 618 of FIG. 6). In such embodiment, in response to the user selecting the checklist creation option, the generated GUI 800B is generated to include a checklist indicator 822 to indicate the existence of a checklist for the appointment item. Upon creation of the checklist, the existence of the checklist becomes a contingency parameter (e.g., checklist indicator parameter) that defines an aspect of the appointment item. The checklist indicator 822 enables the user, upon selecting the indicator 822, to add a set of one or more sub-items (e.g., task items) for the particular appointment item (e.g., by inputting the sub-items), where the set of sub-items operates as the checklist associated with the appointment item. An example of the particular appointment item is “New Client Meeting” and example sub items can include “Make venue reservation” and “Print report.” Accordingly, according to the embodiment of FIG. 8B, a user can add a checklist to any appointment item, and can open the checklist directly from the appointment item (e.g., via the checklist indicator 822). Upon the user clicking on the checklist indicator 822, the set of one or more sub-items associated with the appointment item are displayed.

In some embodiments, the generated GUI 800B includes a remove checklist option 838. The remove checklist option 838 enables the user to remove, or delete, the checklist (e.g., the checklist that has been created by selecting the checklist creation option 618 of FIG. 6).

In some embodiments, the generated GUI 800B also includes an item type field 802 (similar to the item type field 602 of FIG. 6), an item name field 824 (similar to the item name field 604 of FIG. 6), an appointment item date field 826 (similar to the appointment item date field 606 of FIG. 6), an appointment target time field 828 (similar to the appointment target time field 608 of FIG. 6), a detailed note option 830 (similar to the detailed note option 610 of FIG. 6), a tag option 832 (similar to the tag option 612 of FIG. 6), and a repeat option 836 (similar to the repeat option 616 of FIG. 6). In some embodiments, the GUI 800B includes a project assignment option 834 (similar to the project assignment option 614 of FIG. 6). In some embodiments, the generated GUI 800B includes a delete option 840 (similar to the delete option 622 of FIG. 6). The delete option 820 enables the user to remove, or delete, the particular appointment item.

FIGS. 9A-9D illustrates various graphical user interfaces (GUIs) 900A, 900B, 900C, 900D for creating a project associated with a task item and/or an appointment item. The GUIs 900A, 900B, 900C, 900D can be presented on a display of a user device (e.g., user device 102 of FIG. 1). According to one embodiment, a user can interact with various features of the GUIs 900A-D, respectively, to submit one or more contingency parameters in creating a project associated with either a task item or an appointment item.

FIG. 9A illustrates a GUI 900A that allows a user to create a project associated with a task item by interacting with the GUI 900A (e.g., using a mouse, touchscreen, keyboard, microphone, etc.). According to one embodiment, the GUI 900A is generated in response to the user selecting a project creation option included in a GUI for creating and/or editing a particular task item. For example, in response to a selection of the project creation option 520 displayed on the GUI 500A of FIG. 5A and/or FIG. 5C, the GUI 900A is generated. In another example, the GUI 900A is generated in response to the user selecting the project creation option 620 displayed on the GUI 600 of FIG. 6.

The generated GUI 900A includes a project indicator 922. The project indicator 922 enables the user, upon selecting the indicator 922, to generate a project from the particular task item. For example, the user creates a task item “Fix Bicycle” and decides to transform, or convert, that task item into a project “Fix Bicycle.” The project “Fix Bicycle” provides the advantage of enabling the user to add additional tasks and/or appointments to the “Fix Bicycle” planning item. Examples for such additional tasks can include “Buy new tires,” “Buy air pump,” “Fix Frame,” etc. Examples for such additional appointments can include “Meeting with bike expert,” “Meeting with tire specialist,” etc.

In some embodiments, the generated GUI 900A also includes an item type field 902 (similar to the item name field 504 of FIG. 5A), an item name field 904 (similar to the item name field 504 of FIG. 5A), a subtype field 906 (similar to the subtype field 506 of FIG. 5A), a task item date field 908 (similar to the task item date field 508 of FIG. 5A), a detailed note option 910 (similar to the detailed note option 510 of FIG. 5A), a tag option 912 (similar to the tag option 512 of FIG. 5A), and a repeat option 916 (similar to the repeat option 516 of FIG. 5A). In such embodiments, the fields 902, 904, 906, 908, 910, 912, and 916 can be additional contingency parameters that define a planning item. In some embodiments, the generated GUI 900A includes a project assignment option 914. In such embodiments, the project assignment option 914 can be a contingency parameter that defines a planning item. In some embodiments, the generated GUI 900A includes an unmake project option 918 and a delete option 920 (similar to the delete option 522 of FIG. 5A). The unmake project option 918 enables the user to remove, or delete, the project (e.g., the project that has been created by selecting the project creation option). The delete option 920 enables the user to remove, or delete, the particular task item.

According to one embodiment, a particular GUI, of the GUIs 900B-900D, can be selectively presented on the user device's display based on a project view pane selection 940 selected by the user. Each GUI can represent a view pane for displaying (at least a portion of) calendar information associated with one or more different subsets of the planning items included in a particular project. The following description will discuss further details of each selected GUI.

FIG. 9B illustrates a GUI 900B that allows a user to create and/or edit one or more task items and/or one or more appointment items for a particular project by interacting with the GUI 900B (e.g., using a mouse, touchscreen, keyboard, microphone, etc.). According to one embodiment, the GUI 900B is generated in response to the user selecting a project indicator included in a GUI for creating and/or editing a project. For example, the user selects the project indicator 922 displayed on the GUI 900A of FIG. 9A, and the GUI 900B of FIG. 9B is generated in response. According to one embodiment, the GUI 900B is generated to include a PLAN project view pane 950, in response to a user selecting a PLAN project view pane selection 940A.

The PLAN view pane 950 provides a non-filtered, overall view of planning items to assist the user in the personal planning of short and long-term goals for a particular project (e.g., Project “Fix Bicycle”). In particular, the PLAN view pane 950 displays both active items and inactive (i.e., non-actionable) items (that have the status of incomplete) to enable the user to view all planning items that have been submitted by the user (e.g., by inputting one or more contingency parameters). In some embodiments, the PLAN view pane 950 can also display completed items (i.e., items that have the status of complete). In such embodiments, the completed items can be visually displayed as crossed-out to differentiate them from other items that are not yet completed.

In the embodiment of FIG. 9B, the PLAN project view pane 950 includes a simplified project calendar 960 for the current week associated with the project “Fix Bicycle.” In some embodiments, the PLAN project view pane 950 can also include a list of relevant dates for a particular project. The list of relevant dates can be configured by a user or by a system admin to display a specified or predetermined number of dates. In one example, the list of relevant dates can be configured to display dates for remaining days of the week associated with a current date 410 (e.g., “June 26,” “June 27,” “June 28,” and “June 29”), regardless of whether there is a planning item scheduled for any of those remaining dates. In another example, the list of relevant dates can be configured to display only dates at which planning items are scheduled. In yet another example, the list of relevant dates can be configured to display the remaining dates of the week and any subsequently chronological dates with planning items scheduled; this example is shown in the embodiment of FIG. 9B with the dates 962 and 964 and the dates 966 displayed. A project end date 968 is also displayed to provide a reference point for the user regarding the project's end date.

In the illustrated embodiment of FIG. 9B, each of the planning items in the list of relevant dates is chronologically displayed based on the date the project's planning item is scheduled. The term “scheduled” as used here refers to the item date of a planning item. Under the current date 962 (i.e., “TODAY”), planning items 970A and 970B scheduled for “JUNE 29” are displayed; that is, each of the planning items 970A and 970B has an item date of June 29. The next relevant date that is not part of the remaining week is a date 966. The PLAN project view pane 950 includes the date 966 because it is the first chronological date subsequent to the current week that has the planning items 972A and 972B scheduled.

In some embodiments, the PLAN project view pane 950 includes an insertion point marker 930B that can be used in conjunction with an insertion option 930A within the view pane 950 to allow a user to add one or more additional planning items. For example, the user can use the marker 930B and insertion option 930A to submit one or more contingency parameters related to a particular planning item. A user can place the insertion point marker 930B (e.g., mouse-click, touchscreen, etc.) at a particular position between any two dates (e.g., dates 962 and 964), or any two existing planning items associated with the dates (e.g., items 970A and 970B), to indicate a particular date at which to insert, or add, the particular planning item to the Calendar App. The user can next select the insertion option 930A to add the particular planning item at the particular position of the insertion point marker 930B. The particular planning item can be, for example, a task item or an appointment item. Note that in the illustrated embodiment of FIG. 900B, only the remaining dates of the month of “JUNE” are displayed (i.e., dates 962 and 964), and that only the next chronological date that has a scheduled planning item (i.e., date 966 of “JULY 7”) is displayed, disregarding the dates in between June and July 7 that do not have a scheduled planning item (“empty dates”). In other embodiments, however, additional empty dates can be displayed. For example, the empty dates of “JULY 1 to JULY 7” can be displayed. As discussed above, the list of relevant dates can be configured or specified by the user or a system admin.

FIG. 9C illustrates a GUI 900C that includes an ACT project view pane 980 for displaying at least a portion of calendar information related to a subset of one or more items associated with a particular project (e.g., Project “Fix Bicycle”). The ACT project view pane 980 can be generated in response to the user selecting (e.g., mouse-click, touch, keyboard input, etc.) the ACT project view pane selection 940B. The ACT project view pane 980 provides a filtered view of the planning items associated with a particular project to assist the user in focusing on certain items that are “actionable” without the distraction of other items. In particular, the ACT project view pane 980 displays only the items that are categorized as active items to indicate an importance of those particular items (in comparison to the inactive items associated with the particular project that are not needed to be shown to the user). Such active items are those items that the user, e.g., can act upon or perform in an efficient manner. Whether a planning item is an active item depends on the item type, as discussed above with respect to FIG. 3B.

According to the embodiment illustrated in FIG. 9C, the ACT project view pane 980 includes a first list of active items (e.g., active items 984A-C) and a second list of active items (e.g., active items 988A-C). The first list of active items is associated with a current date 982 (i.e., “TODAY”) and the second list of active items is associated with a future date 982 (i.e., “AHEAD”). The items in the first and second list of active items are displayed in a chronological order based on their respective item dates. The active items in the first and second lists can include a task item and/or an appointment item. In some embodiments, the active items in the first and second lists can include a calendar note. In some embodiments, the items included in the first list of active items can be those items with item dates in a date range extending from “TODAY” until the end of the current month, and the items in the second list of active items are those with item dates beyond the current month. The date range and the item types that are included in the first and second lists can be configured by a system administrator or a user.

In some embodiments, the ACT project view pane 980 also includes a project end date 989 displayed to provide the user a reference point associated with the particular project's end date. In some embodiments, the ACT view pane 440 enables the user to mark any item included in the first list and the second list, respectively, as “Completed” by interacting with the item, e.g., select on a circle next to the item.

In the illustrated embodiment of FIG. 9C, the ACT project view pane 980 includes the first list associated with the current date 982 and the second list associated with the future date 986. Planning items 1-n (where n is an integer) 984A-C displayed within the first list can be items that can be acted upon. For example, the items 984A-C can be planning items that are of the task type and are assigned each with an active date (e.g., January 1) that is before the current date 982, or planning items of the task type that are assigned each with an active date of “TODAY,” or planning items that are of the task type and are each assigned with the active date of “TODAY” (and hence the active date “goes away” on the arrival of “TODAY”), or planning items of the task type with no active date assigned to each, or planning items of the appointment type and have the item date (i.e., appointment date) of “TODAY,” or any combination thereof. THe items 984A-C can be organized chronologically based on their respective item dates. Further, in the example, the planning items 988A-C (i.e., items 1-n, where n is an integer) displayed within the second list associated with the future date 986 can be items that are actionable (i.e., active items), but have item dates that are not immediate (e.g., item dates of next month). Other embodiments as discussed above can be applied in the selection of planning items to be displayed within the first and second lists of the ACT project view pane 980.

FIG. 9D illustrates the GUI 900D to include a DONE project view pane 990. The DONE project view pane 990 displays at least a portion of calendar information (e.g., item name and completion date) related to a subset of all planning items associated with a particular project (e.g., Project “Fix Bicycle”). The DONE project view pane 990 can be generated in response to the user selecting (e.g., mouse-click, touch, keyboard input, etc.) the DONE project view pane selection 940C.

The DONE project view pane 990 provides a filtered view of the planning items to assist the user in viewing only some items (of all planning items) without the distraction of the other items. In particular, the DONE project view pane 990 displays only completed items (i.e., items with the status of complete). Such completed items include any planning item(s) (e.g., task item or appointment item) that have been marked as “completed” item(s). A planning item can be marked as completed by a user. For example, the user can view the planning items (i.e., active items) in the ACT view pane 940B and select a circle next to an item to indicate completion. In another example, the user can view and update a contingency parameter (e.g., status parameter) of a planning item to change the status to complete. Alternatively, a planning item can be marked as completed by the Calendar App upon a time passing of the occurrence of the item. For example, an appointment set for June 30 at 9 AM can be automatically marked as completed at a date and/or time subsequent to the appointment's item date/time (e.g., June 30 at 9:01 AM, July 1 at 9 AM, etc.).

In some embodiments, the DONE project view pane 990 displays the completed items organized in a chronological order based on the date at which each item has been completed. As illustrated in the embodiment of FIG. 9D, the DONE project view pane 990 displays, for example, a first past date 992 of “JUNE 28” and accompanying completed items 1-n (i.e., items 996A-C) (where n is an integer). Chronologically subsequent to the first past date 992 is a second past date 994 of “TODAY” that is accompanied by completed item 998. In the embodiment illustrated in FIG. 900C, no other items have been completed except for those shown for the dates 992 and 994. As such, other past dates, e.g., dates before the date 992, are not displayed within the DONE project view pane 990. According to the embodiment, the DONE project view pane 990 also includes a project end date 999 to provide to the user a reference point associated with the project's end date. In some embodiments, the DONE project view pane 990 displays the completed items organized in a chronological order based on the item date of each completed item (as opposed to the date of completion).

FIGS. 10A-10B illustrate example graphical user interfaces (GUIs) 1000A and 1000B associated with the project assignment option for categorizing a planning item as a planning item of a project. The GUIs 1000A, 1000B can be presented on a display of a user device (e.g., user device 102 of FIG. 1).

According to one embodiment, the GUI 1000A is generated in response to a user selecting a project assignment option 1006 included in a GUI for creating and/or editing a particular task item 1002. The project assignment option 1006 can be the project assignment option 514 of FIG. 5A. In particular, upon selection of the project assignment option 1006, a list (or set) of available projects are displayed to the user (not shown). The user can then select any of the available project to assign to the particular task item 1002. For example, in response to the selection of a particular project, the GUI 1000A is generated to display the task item 1002 with a project assignment indicator 1004 (e.g., “Fix Bicycle”) to indicate the project that has been selected by the user for the particular task item 1002. In the illustrated embodiment of FIG. 10A, the particular task “Paint Frame” 1002 is categorized to be a task item of the project “Fix Bicycle” 1004.

According to one embodiment, the GUI 1000B is generated in response to a user selecting a project assignment option 1014 included in a GUI for creating and/or editing a particular appointment item 1010. The project assignment option 1014 can be the project assignment option 614 of FIG. 6. In particular, upon selection of the project assignment option 1014, a list (or set) of available projects are displayed to the user (not shown). The user can then select any of the available project to assign to the particular appointment item 1010. For example, in response to the selection of a particular project, the GUI 1000B is generated to display the appointment item 1010 with a project assignment indicator 1012 (e.g., “Fix Bicycle”) to indicate the project that has been selected by the user for the particular appointment item 1010. In the illustrated embodiment of FIG. 10B, the particular appointment “Meet with bicycle expert” 1010 is categorized, or included, to be an item of the project “Fix Bicycle” 1012.

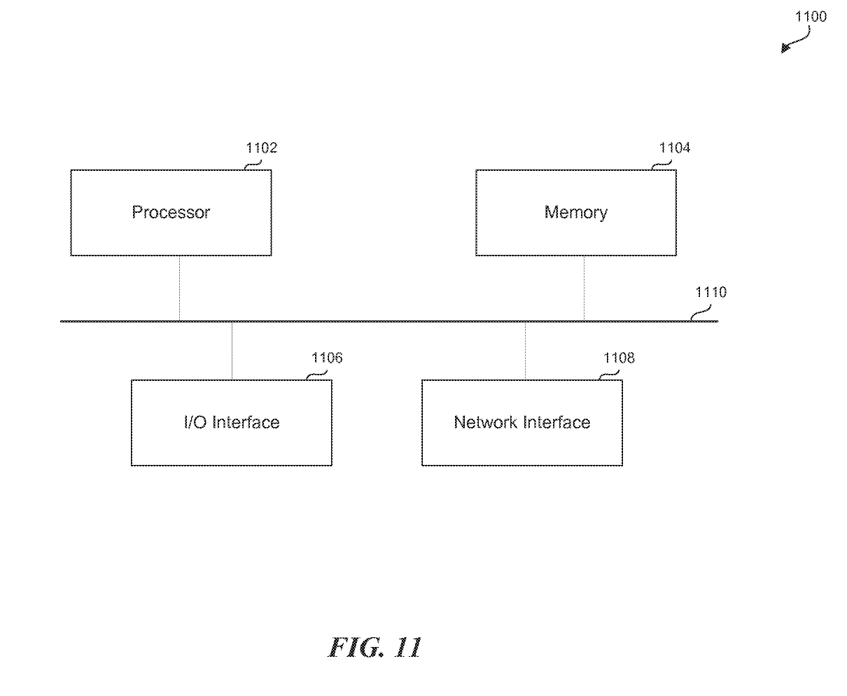

FIG. 11 illustrates a block diagram of an architecture for a computer system 1100 that may be utilized to implement the techniques described herein. Referring to FIG. 11, the computer system 1100 includes one or more processors 1102 and one or more memories 1104 connected via an interconnect 1110. The interconnect 1110 is an abstraction that represents any one or more separate physical buses, point to point connections, or both connected by appropriate bridges, adapters, or controllers. The interconnect 1110, therefore, may include, for example, a system bus, a Peripheral Component Interconnect (PCI) bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 594 bus, sometimes referred to as “Firewire”.

The processor(s) 1102 may include central processing units (CPUs) to control the overall operation of, for example, the host computer. In certain embodiments, the processor(s) 1102 accomplish this by executing software or firmware stored in memory 1104. The processor(s) 1102 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

The memor(ies) 1104 is or includes the main memory of the computer system 1100. The memor(ies) 1104 may be any form of random access memory (RAM), read-only memory (ROM), flash memory (as discussed above), or the like, or a combination of such devices. In use, the memor(ies) 1104 may contain, among other things, a set of machine instructions which, when executed by processor 1102, causes the processor(s) 1102 to perform operations to implement embodiments of the present invention.

Also connected to the processor(s) 1102 through the interconnect 1110 is a network adapter 1115. The network adapter 1108 provides the computer system 1100 with the ability to communicate with remote devices, such as the storage clients, and/or other storage servers, and may be, for example, an Ethernet adapter or Fiber Channel adapter.

The system 1100 may also include one or more input/output (I/O) interfaces 1106. The input interfaces may include a keyboard, a mouse or other pointing device. The output interfaces may include a display devices, such as a cathode ray tube (CRT), liquid crystal display (LCD), or some other applicable known or convenient display device, a speaker device, or other output interfaces.

What is claimed is:

1. A method for organizing a set of data items in a calendar user interface, the set of data items including any of a task item, an appointment item, or a calendar note item, the method comprising:
receiving a set of contingency parameters that define the set of data items, the set of contingency parameters including a set of item dates corresponding to the set of data items, a set of item statuses corresponding to the set of data items, and a set of item types corresponding to the set of data items, the set of item types including any of a task type, an appointment type, or a calendar note type;
for each data item of the set of data items, categorizing the data item as an active data item or an inactive data item based on a corresponding item type;
identifying a first subset of the set of data items that contains one or more data items categorized as active data items; and
generating the first subset of the set of data items for display in an action view pane of the calendar user interface, wherein the action view pane contains only the one or more data items categorized as active data items.

2. The method of claim 1, wherein said categorizing of the data item comprises:
categorizing the data item as the active item if the corresponding item type is the appointment type and a corresponding item date of the data item is a current date, the current date being a date of today.

3. The method of claim 1, wherein said categorizing of the data item comprises:
categorizing the data item as the active item if the corresponding item type is the calendar note type and a corresponding item date of the data item is a current date, the current date being a date of today.

4. The method of claim 1, wherein the set of contingency parameters further includes a set of active dates corresponding to a selected set of data items of the set of data items, wherein each active date of the set of active dates is received from any of: a user assigning the active date to each data item of the selected set of data items through the calendar user interface; or an application executing the calendar user interface.

5. The method of claim 4, wherein the selected set of data items include one or more data items of the task type.

6. The method of claim 4, wherein said categorizing of the data item comprises:
categorizing the data item as the active item if the corresponding item type is the task type, there is no active date assigned to the data item, and a corresponding status of the data item is incomplete.

7. The method of claim 4, wherein said categorizing of the data item comprises:
categorizing the data item as the active item if the corresponding item type is the task type, a corresponding status of the data item is incomplete, and the active date assigned to the data item is prior to a current date, the current date being a date of today.

8. The method of claim 4, further comprising:
updating the first subset of the set of data items in the action view pane based on the set of active dates received.

9. The method of claim 1, wherein the first subset of the set of data items in the action view pane is organized in a chronological order.

10. The method of claim 1, further comprising:
generating the set of data items for display in a planning view pane of the calendar user interface, wherein the set of data items is organized in a chronological order based on the set of item dates, wherein the planning view pane includes both active and inactive data items.

11. The method of claim 1, further comprising:
receiving an indication of completion for at least one given data item of the set of data items;
updating a corresponding status from incomplete to complete for the at least one given data item;
identifying a second subset of the set of data items that contains the at least one given data item with the corresponding status of complete; and
generating the second subset of the set of data items for display in a completion view pane of the calendar user interface.

12. The method of claim 1, further comprising:
identifying, from the set of data items, a selected set of data items that contains one or more data items of the task type; and
for each data item of the selected set of data items:
generating, for display in a timeline view pane of the calendar user interface, an item timeline associated with the data item, the item timeline including a plurality of timeline points extending from a current date to a corresponding item date, the current date being a date of today;
receiving a selection of a particular timeline point indicative of a corresponding active date for the data item; and
updating, for display in the timeline view pane of the calendar user interface, the item timeline to extend from the corresponding active date to the corresponding item date in response to the selection of the particular timeline point.

13. The method of claim 12, further comprising updating the first subset of the set of data items in the action view pane based on the corresponding active date.

14. The method of claim 12, further comprising:
in response to the selection of the particular timeline point,
re-categorizing the data item as the inactive data item if a current date is prior to the corresponding active date, the current date being a date of today; and
removing, from display in the action view pane of the calendar user interface, the data item re-categorized as the inactive data item.

15. A graphical user interface (GUI) that facilitates displaying of a user's planning items associated with a calendar, the planning items including any of a task item, an appointment item, or a calendar note item, the GUI comprising:
a first view pane to display the planning items, the planning items having corresponding contingency parameters that define the planning items, the corresponding contingency parameters including an item date corresponding to each planning item and an item type corresponding to each planning item, the item type including any of a task type, an appointment type, or a calendar note type;
a second view pane to display a subset of the planning items, the subset including one or more items of the planning items categorized as active data items based on the item date and the item type; and
wherein each of the first and second view panes includes a settings component that allows the user to change one or more of the contingency parameters of any of the planning items, wherein the first and second view panes are configured to update simultaneously in response to the one or more of the contingency parameters received from the user.

16. The GUI of claim 15, wherein a particular planning item is categorized as an active data item if the item type of the particular planning item is the appointment type and the item date of the particular planning item is a current date.

17. The GUI of claim 15, wherein the corresponding contingency parameters further include an active date assigned to each of a selected set of planning items, wherein the active date is received from any of: the user to indicate a constraint associated with each of the selected set of planning items; or an application executing the calendar user interface.

18. The GUI of claim 17, wherein the selected set of planning items includes one or more selected planning items, from the planning items, that are of the task type.

19. The GUI of claim 17, wherein a particular planning item is categorized as an active data item if the item type of the particular planning item is the task type, there is no active date assigned to the particular planning item, and a status of the particular data item is incomplete.

20. The GUI of claim 17, wherein a particular planning item is categorized as an active data item if the item type of the particular planning item is the task type, the active date assigned to the particular planning item is prior to a current date, and a status of the particular planning item is incomplete.

21. The GUI of claim 15, further comprising:
a third view pane to display a second subset of the planning items, the second subset including one or more given items of the planning items having a status of complete based on an input received, from the user, to indicate completion of the one or more given items.

22. The GUI of claim 21, wherein each of the first, second, and third view panes is presented to the user one at a time in response to a selection of a particular view pane from the user.

23. The GUI of claim 15, wherein the contingency parameters further includes any of: a data item name, an active date, a tag, or a project assignment.

24. A method for organizing a set of planning items in a calendar user interface, comprising:
receiving, from a user, the set of planning items, wherein each planning item of the set of planning items is associated with a set of contingency parameters that define the set of planning items, wherein the set of planning items include any of a task item, an appointment item, or calendar note item; and
generating a plurality of view panes for display in the calendar user interface, wherein the plurality of view panes are generated to include different corresponding subsets of the set of planning items, each subset including one or more planning items, from the set of planning items, that are automatically organized into the subset based on the set of contingency parameters.

25. The method of claim 24, wherein the set of contingency parameters comprises any of an item name, an item type, an active date, an item date, an item status, a tag, or a project assignment.

26. The method of claim 25, wherein the item type comprises any one of a task type, an appointment type, or a calendar-note type.

27. The method of claim 26, wherein the plurality of view panes comprises a first view pane and a second view pane, and wherein the method further comprises:
populating the first view pane with a first subset of the set of planning items, the first subset including all planning items of the set of planning items organized chronologically based on the item date of each planning item; and
populating the second view pane with a second subset of the set of planning items, the second subset including one or more selected planning items, of the set of planning items, that are categorized as active items based on the item type of each of the selected one or more planning items.

28. The method of claim 27, wherein the plurality of view panes further comprises a third view pane, and wherein the method further comprises:
populating the third view pane with a third subset of the set of planning items, the third subset including one or more given planning items, of the set of planning items, having the item status of complete.

29. The method of claim 27, wherein each of the selected one or more planning items is categorized as the active item if the item type is the task type, the item status is incomplete, and the active date assigned to the selected planning item is prior to a current date.

30. The method of claim 27, wherein each of the selected one or more planning items is categorized as the active item if the item type is the task type, the item status is incomplete, and there is no active date assigned to the selected planning item.
